(19) United States
(12) Patent Application Publication
(10) Pub. No.: US 2026/0286029 A1
(43) Pub. Date: Sep. 24, 2026

(54) POLYMER DISPERSIONS OF POLYMERS P

(71) Applicant: BASE SE, Ludwigshafen am Rhein (DE)

(72) Inventors: Martin Robert SCHEUBLE, Ludwigshafen am Rhein (DE); Thomas WOLF, Ludwigshafen am Rhein (DE); Konrad ROSCHMANN, Ludwigshafen am Rhein (DE)

(21) Appl. No.: 19/476,204

(22) PCT Filed: Apr. 18, 2024
(86) PCT No.: PCT/EP2024/060628

§ 371 Date: Oct. 17, 2025

(30) Foreign Application Priority Data
Apr. 20, 2023 (EP) 23169033.0

(51) Int. Cl. C08F 220/14; C08F 2/22; C08F 2/38; C08K 5/36

(52) U.S. Cl. CPC C08F 220/14; C08F 2/22; C08F 2/38; C08K 5/36

(57) ABSTRACT

The present invention relates to aqueous polymer dispersions of polymers P which are obtainable by aqueous emulsion polymerization of ethylenically unsaturated monomers M and at least one chain transfer compound C, where the monomers M comprise at least one monoethylenically unsaturated monomer M1 and at least one multiethylenically unsaturated monomer M2, where the polymer P comprises a multitude of hydrolytically cleavable functional groups CFG within its carbon chain formed by the polymerization of the ethylenically unsaturated double bonds of the monomers M such that the functional groups CFG interrupt the carbon chain of the polymer P, where the relative amount of the functional groups CFG is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

The present invention relates to a method for producing an aqueous polymer dispersion as described herein, which comprises an aqueous emulsion polymerization, in particular a free radical aqeuous emulsion polymerization, of the monomers M and the chain transfer compound, where the amount of the chain transfer compound C and the type and amount of monomers M2 is chosen such that the resulting polymer contains hydrolytically cleavable functional groups CFG which interrupt the carbon chain of the polymer provided, where the relative amount of the functional groups CFG is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

The present invention relates to aqueous polymer dispersions of polymers P, which are obtainable by an aqueous emulsion polymerization of ethylenically unsaturated monomers M and at least one chain transfer compound C, where the monomers M comprise monoethylenically unsaturated monomers M1 and multiethylenically unsaturated monomers M2.

Aqueous polymer dispersions of polymerized ethylenically unsaturated monomers, also referred to as polymer latices, are fluid systems comprising dispersed polymer particles of a chain growth addition polymer in an aqueous dispersing medium. Depending on the polymer architecture of the dispersed polymer particles, the polymer dispersions can be used across a plethora of technical applications, including binders for paints, architectural as well as industrial coatings, binders for paper coatings, binders in adhesives, binders for fibre bonding, organic opacifiers, rubbers and impact modifiers for thermoplastics.

Aqueous polymer dispersions are typically produced by aqueous emulsion polymerization, in particular prepared by a free radical aqueous emulsion polymerization of ethylenically unsaturated monomers, which include in particular monoethylenically unsaturated monomers, such as monovinyl aromatics such as styrene or vinyl toluene, mono- and conjugated diolefins, such as butadiene, isoprene or ethene, esters of α,β-ethylenically unsaturated acids, in particular the esters of acrylic acid or methacrylic acid, vinyl or allyl ethers and vinyl or allyl esters of alkanoic acids, and combinations thereof. The emulsion polymerization typically results in mostly linear polymers having an all-carbon backbone. The procedure for radically initiated emulsion polymerizations of monomers in an aqueous medium has been extensively described and is therefore sufficiently familiar to the skilled person [cf. in this regard Emulsion Polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422; Dispersionen synthetischer Hochpolymerer, F. Hölscher, Springer-Verlag, Berlin (1969), D. Urban, K. Takamura (ed.) “Polymer Dispersions and Their Industrial Applications”, Wiley VCH, Weinheim 2002)]. Detailed mechanistic studies have been summarized e. g. by C. S. Chern, Prog. Polym. Sci. 31 (2006) 443-486; and by M. Nomura et al., Adv. Polym. Sci. 175 (2005) 1-128.

While the polymer dispersions described in the art have particular advantages in one or more aspects, the biodegradability of the polymers contained therein is poor due to their all-carbon backbone and their high molecular weight. Therefore, aqueous polymer dispersions may contribute to the introduction of micro-plastic into the environment. Consequently, there is an ongoing need to reduce the introduction of micro-plastic caused by aqueous polymer dispersions.

Introduction of micro-plastic can be reduced by using aqueous polymer dispersions obtained in the presence of polysaccharides, such as degraded starch. However, it can be difficult to tailor the properties of such polymer dispersions for the desired application and it is not possible to achieve polymer dispersions which are completely degradable. Apart from this, the use of starch increases the risk of microbial spoiling.

It is well known to tailor the application properties of polymer dispersions by modifying the polymer architecture of the polymers contained therein. This can be done by using functional or multi-ethylenically unsaturated monomers, which result in branching or crosslinking of the polymer chain and increase of the molecular weight, by including polar monomers, by selecting monomer combinations for adjusting a specific softening temperature or glass transition temperature and by using chain transfer agents in the emulsion polymerization process to reduce the molecular weight of the polymer chain.

To date, however, there are no known polymer dispersions whose polymers can be easily and completely degraded to water-soluble degradation products. Moreover, the aqueous polymer dispersions should be easily prepared by analogy to conventional aqueous emulsion polymerization processes.

It was now found that polymers contained in the aqueous polymer dispersions are degradable, if the polymers comprises a multitude of hydrolytically cleavable functional groups CFG within their carbon chain formed by the polymerization of the ethylenically unsaturated double bonds of the monomers M such that the functional groups CFG interrupt the carbon chain of the polymer and if the relative amount of the functional groups CFG in the polymers is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P. Due to the polymer architecture the polymer P degrades to low molecular weight oligomer or polymer fragments under hydrolytic conditions. These oligomers and polymer fragments are better soluble in aqueous media and thus are more amenable to further degradation under environmental conditions than conventional high molecular weight emulsion polymers.

It was also found that the functional groups CFG can be introduced into the polymer backbone of the polymers of the aqueous polymer dispersions by using suitable amounts of multiethylenically unsaturated monomers having at least one functional groups CFG and/or suitable amounts of chain transfer compounds C having at least one functional group CFG. In other words, the aqueous polymer dispersions can be produced by aqueous emulsion polymerization of ethylenically unsaturated monomers M comprising at least one monoethylenically unsaturated monomer M1 and at least one multiethylenically unsaturated monomer M2, in an aqueous emulsion polymerization in the presence of at least one chain transfer compound, where the amount of the chain transfer compound C and the type and amount of monomers M is chosen such that the resulting polymer contains the above amounts of hydrolytically cleavable functional groups CFG which interrupt the carbon chain of the polymer.

Therefore, a first aspect of the present invention relates to aqueous polymer dispersions of polymers P which are obtainable by aqueous emulsion polymerization of ethylenically unsaturated monomers M and at least one chain transfer compound C, where the monomers M comprise at least one monoethylenically unsaturated monomer M1 and at least one multiethylenically unsaturated monomer M2, where the polymer P comprises a multitude of hydrolytically cleavable functional groups CFG within its carbon chain formed by the polymerization of the ethylenically unsaturated double bonds of the monomers M such that the functional groups CFG interrupt the carbon chain of the polymer P, where the relative amount of the functional groups CFG is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

A second aspect of the present invention relates to aqueous polymer dispersions of polymers P which are obtainable by aqueous emulsion polymerization of ethylenically unsaturated monomers M and at least one chain transfer compound C, where the monomers M comprise at least one monoethylenically unsaturated monomer M1 and at least one multiethylenically unsaturated monomer M2, where the polymer P comprises a multitude of hydrolytically cleavable functional groups CFG within its carbon chain formed by the polymerization of the ethylenically unsaturated double bonds of the monomers M such that the functional groups CFG interrupt the carbon chain of the polymer P, where the monomers M2 and/or the chain transfer compound C comprise functional groups CFG in such an amount that the relative amount of the functional groups CFG which is provided by the monomers M2 and the chain transfer compound is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

A further aspect of the present invention relates to a method for producing an aqueous polymer dispersion as described herein, which comprises an aqueous emulsion polymerization, in particular a free radical aqeuous emulsion polymerization, of the monomers M and the chain transfer compound, where the amount of the chain transfer compound C and the type and amount of monomers M2 is chosen such that the resulting polymer contains hydrolytically cleavable functional groups CFG which interrupt the carbon chain of the polymer provided, where the relative amount of the functional groups CFG is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

The invention is associated with several benefits. Since the polymers contained in the aqueous polymer dispersion of the present invention contain a considerable amount of hydrolytically cleavable functional groups CFG which interrupt the carbon chain or carbon backbone of the polymer P contained in the polymer dispersion, the polymer can be cleaved by hydrolytic treatment to form low molecular weight oligomer or polymer fragments which are better soluble in aqueous media and thus are more amenable to further degradation under environmental conditions than conventional high molecular weight emulsion polymers. Moreover, the functional groups CFG allow the polymer chain to be degraded under aqueous hydrolytic conditions, thus facilitating the recycling of products containing the polymer P as a binder. In particular, a simple hydrolytic or enzymatic treatment of products containing polymer P in an aqueous medium will result in a dissolution of the polymer fragments and thus allow for removal of the polymer fragments from the other components of the product.

Here and throughout the specification, the term “(meth)acryl” includes both acryl groups (—C(═O)—CH═CH₂) and methacryl groups (—C(═O)—C(CH₃)═CH₂). Hence, the term “(meth)acrylate” includes acrylate and methacrylate and the term “(meth)acrylamide” includes acrylamide and methacrylamide.

The term “free radical aqueous emulsion polymerization” means that the polymerization of the monomers M is initiated by radicals formed by the decay of a polymerization initiator, whereby free radicals are formed in the polymerization mixture. It is therefore also termed “radically initiated emulsion polymerization”.

Here and throughout the specification, the term “waterborne coating composition” means a liquid aqueous coating composition containing water as the continuous phase in an amount sufficient to achieve flowability.

Here and throughout the specification, the terms “wt.-%” and “% by weight (% b.w.)” are used synonymously.

Here and throughout the specification, the term “pphm” means parts per 100 parts of monomers, i.e. parts by weight per 100 parts by weight of monomers and corresponds to the relative amount in % by weight of a certain substance, based on the total amount of monomers M.

Here and throughout the specification, the term “ethylenically unsaturated monomer” is understood that the monomer has at least one C═C double bond, e.g. 1, 2, 3 or 4 C═C double bonds, which are radically polymerizable, i.e. which under the conditions of an aqueous radical emulsion polymerization process are polymerized to obtain a polymer having a backbone of carbon atoms. Here and throughout the specification, the term “monoethylenically unsaturated” is understood that the monomer has a single C═C double bond, which is susceptible to radical polymerization under conditions of an aqueous radical emulsion polymerization.

Here and throughout the specification, the terms “ethoxylated” and “polyethoxylated” are used synonymously and refer to compounds having an oligo- or polyoxyethylene group, which is formed by repeating units O—CH₂CH₂. In this context, the term “degree of ethoxylation” relates to the number average of repeating units O—CH₂CH₂ in these compounds.

Here and throughout the specification, the term “non-ionic” in the context of compounds, especially monomers, means that the respective compound does not bear any ionic functional group or any functional group, which can be converted by protonation or deprotonation into an ionic group.

Here and throughout the specification, the prefixes Cₙ-Cₘ used in connection with compounds or molecular moieties each indicate a range for the number of possible carbon atoms that a molecular moiety or a compound can have. The term “C₁-Cₙ alkyl” denominates a group of linear or branched saturated hydrocarbon radicals having from 1 to n carbon atoms. The term “Cₙ/Cₘ alkyl” denominates a mixture of two alkyl groups, one having n carbon atoms while the other having m carbon atoms.

For example, the term C₁-C₂₀ alkyl denominates a group of linear or branched saturated hydrocarbon radicals having from 1 to 20 carbon atoms, while the term C₁-C₄ alkyl denominates a group of linear or branched saturated hydrocarbon radicals having from 1 to 4 carbon atoms and the C₅-C₂₀ alkyl denominates a group of linear or branched saturated hydrocarbon radicals having from 5 to 20 carbon atoms. Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl, docosyl and their isomers, in particular mixtures of isomers such as “isononyl”, “isodecyl”. Examples of C₁-C₄-alkyl are for example methyl, ethyl, propyl, 1-methylethyl, butyl, 1-methylpropyl, 2-methylpropyl or 1,1-dimethylethyl.

The term “C₅-C₂₀-cycloalkyl” as used herein refers to an mono- or bicyclic cycloaliphatic radical which is unsubstituted or substituted by 1, 2, 3 or 4 methyl radicals, where the total number of carbon atoms of C₅-C₂₀-cycloalkyl from 5 to 20. Examples of C₅-C₂₀-cycloalkyl include but are not limited to cyclopentyl, cyclohexyl, methylcyclohexyl, dimethylcyclohexyl, cycloheptyl, cyclooctyl, cyclododecyl, cyclohexadecyl, norbornyl (=bicyclo[2.2.1]heptyl) and isobornyl (=1,7,7-trimethylbicyclo[2.2.1]heptyl).

In cycloalkyl, 1 or 2 of the CH₂ groups may be replaced by non-adjacent oxygen ring atoms, resulting in heterocycloaliphatic radicals. These radicals are also referred to as “C₄-C₂₀-heterocycloalkyl”. Examples of C₄-C₂₀-heterocycloalkyl include, but are not limited to oxolan-2-yl, oxolan-3-yl, oxan-2-yl, oxan-3-yl, oxan-4-yl, 1,3-dioxolan-2-yl, 1,3-dioxolan-4-yl, 2,2-dimethyl-1,3-dioxolan-4-yl, 1,4-dioxan-2-yl, 1,3-dioxan-2-yl, 1,3-dioxan-4-yl, 1,3-dioxan-5-yl, 2,2-dimethyl-1,3-dioxan-4-yl, 2,2-dimethyl-1,3-dioxan-5-yl.

The term “alkandiyl” as used herein refers to linear or branched bivalent saturated hydrocarbon radicals having typically from 1 to 10 carbon atoms. Examples include methylene (═CH₂), 1,2-ethandiyl, 1,3-propandiyl, 1-methylethan-1,2-diyl, 1,4-butandiyl, 1,3-butandiyl, 1,5-pentandiyl, 2,2-dimethylpropan-1,3-diyl, 1,6-hexandiyl and the like.

The term “aryl” as used herein refers to an monovalent aromatic carbocyclic radical having typically 6, 10, 12 or 14 carbon atoms, such as phenyl or naphthyl.

The term “arylene” as used herein refers to a divalent aromatic carbocyclic radical having typically 6, 10, 12 or 14 carbon atoms, such 1,2-phenylene, 1,3-phenylene, 1,4-phenylene, 1,2-naphthylene, 2,3-naphthylene, 1,3-naphthylene, 1,4-naphthylene, 1,5-naphthylene, 1,6-naphthylene, 1,7-naphthylene, 1,8-naphthylene, 2,5-naphthylene and 2,6-naphthylene.

The polymer P of the polymer dispersion is formed by polymerized monomers M and the chain transfer agent. As the monomers M have at least one ethylenically unsaturated double bond they polymerize via a chain-growth polymerization reaction. Thereby an all-carbon polymer chain is formed. Since the monomers M comprise at least one multiethylenically unsaturated monomer M2 the resulting polymer P has branching points within the polymer chain, which are formed by the monomers M2. In other words, the monomer M2 results in a linkage of polymer chains formed by the monomers M1. Thus, the polymer P has a network-type or branched polymer architecture, which means that the polymer P has numerous all-carbon polymer chains formed by the monomers M1 connected by the polymerized units of the monomer M2. Use of a proper monomer M2, which has a cleavable functional group CFG located between at least two ethylenically unsaturated double bonds of the monomer M2, will result in connections which can be cleaved hydrolytically. In other words, the functional groups CFG introduced by the monomer M2 interrupt the all-carbon chain of the polymer P. Using a chain transfer agent in the polymerization will result in a reduced chain length of the all-carbon chain of the polymerized monomers M1. In this way, the combination of the cleavable functional groups CFG introduced by the monomer M2 and a reduction in the molecular weight of the all-carbon polymer chains formed by the monomers M1 by the chain transfer agent results in a polymer P which can be cleaved into small polymer fragments. Moreover, the chain transfer agent C can also be used to introduce cleavable functional groups CFG into the polymer chain. This can be achieved, for example, by using multifunctional chain transfer agents, i. e. chain transfer agents C which have at least 2 functional groups which are capable of providing a chain transfer during polymerization of the monomers M and which further have at least one cleavable functional group CFG which is located between at least two chain transfer groups. Here and in the following chain transfer groups are also referred to as chain transfer groups CTG or as groups CTG or CTG groups, respectively. Since the chain transfer compounds C are typically connected with or covalently bound to the polymer chain formed by the polymerized monomers M, this again will result in an interruption of the polymer chain by the functional group CFG introduced via the chain transfer agent C. Apparently, it is also possible to combine multifunctional chain transfer compounds having at least one cleavable functional group CFG which is located between at least two chain transfer groups CTG and a monomer M2 having at least one cleavable functional group CFG located between at least two ethylenically unsaturated double bonds of the monomer M2. However, it may be sufficient, if the monomers M comprise a monomer M2 having at least one cleavable functional group CFG located between at least two ethylenically unsaturated double bonds of the monomer M2 or to use multifunctional chain transfer compounds C having at least one cleavable functional group CFG which is located between at least two chain transfer groups CTG a in the polymerization of the monomers M to achieve the desired introduction of cleavable functional groups CFG into the polymer chain of the polymer P.

According to the invention the polymer P of the aqueous polymer dispersion is formed by the monomers M which comprise at least one monomer M2 and the chain transfer agent, where the monomers M2 and/or the chain transfer compound C provide the required groups CFG. For this, generally at least one and especially both of the conditions are met:
a) the chain transfer compound C has at least 2 functional groups CTG, e. g. 2, 3, 4, 5, or 6 functional groups CTG, which are capable of providing a chain transfer during polymerization of the monomers M, where the chain transfer groups are in particular SH groups, where the at least 2 functional groups CTG are connected by a spacer group which comprises at least one functional group CFG, e. g. 1, 2, 3, 4, 5, or 6 functional groups CFG, which are in particular —C(O)O—;
b) the monomers M2 are selected from monomers which have at least two, e. g. 2, 3, 4, 5 or 6, ethylenically unsaturated double bonds and have at least one cleavable functional group CFG, e. g. 1, 2, 3, 4, 5, or 6 functional groups CFG which are located between the at least two ethylenically unsaturated double bonds of the monomer M2.

Apparently, the polyfunctional chain transfer compounds of condition a) as well as the monomers M2 according to condition b) provide for cleavable functional groups CFG which are incorporated into the polymer backbone of the polymer P and thereby interrupt the carbon chain formed by the polymerization of the monomers M. In contrast thereto, monofunctional chain transfer compounds C having only one functional group CTG typically do not contribute to the functional groups CFG incorporated into the polymer backbone, as they will be incorporated at a terminus of the polymer chain.

Hereinafter monomers M2 having at least one cleavable functional group CFG, e. g. 1, 2, 3, 4, 5, or 6 functional groups CFG, which are located between the at least two ethylenically unsaturated double bonds of the monomer M2 are referred to as monomers M2′.

Hereinafter chain transfer compounds C having at least 2 functional groups CTG, e. g. 2, 3, 4, 5, or 6 functional groups CTG, which are capable of providing a chain transfer during polymerization of the monomers M are referred to as chain transfer compounds Cm, where m indicates the number of functional groups CTG.

Hereinafter chain transfer compounds C having at least 2 functional groups CTG, e. g. 2, 3, 4, 5, or 6 functional groups CTG, which are SH groups (mercapto groups) are referred to as chain transfer compounds CmSH, where m indicates the number of SH groups.

Hereinafter chain transfer compounds C having at least 2 functional groups CTG, e. g. 2, 3, 4, 5, or 6 functional groups CTG, which are capable of providing a chain transfer during polymerization of the monomers M, where the at least 2 functional groups CTG are connected by a spacer group which comprises at least one functional group CFG, are referred to as chain transfer compounds Cm′, where m indicates the number of functional groups CTG.

Hereinafter chain transfer compounds C having at least 2 functional groups CTG, e. g. 2, 3, 4, 5, or 6 functional groups CTG, which are SH groups (mercapto groups) which are connected by a spacer group which comprises at least one functional group CFG, are referred to as chain transfer compounds CmSH′, where m indicates the number of SH groups.

As mentioned above, the amount and type of the chain transfer compound and the amount and type of the monomer M2 is chosen that the relative amount of the functional groups CFG is in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P. However, it may also be possible to provide these compounds in higher amounts such that the amount of groups CFG in the polymer chain of the resulting polymer P is e. g. in the range 0.5 to 20 mol·kg⁻¹, in particular in the range of 0.6 to 10 mol·kg⁻¹ and especially in the range of 0.8 to 8 mol·kg⁻¹ or 1.0 to 6 mol·kg⁻¹ of the polymer P.

It is apparent from the foregoing that the amount of cleavable functional groups CFG can be calculated from the amount of monomers M2 which have a cleavable functional group CFG located between at least two ethylenically unsaturated double bonds of the monomer M2 and from the amount of the multifunctional chain transfer agents Cm′ as defined above, which are in particular chain transfer compounds CmSH′. For example, the relative amount A_{CFG} of the groups CFG in mol/kg can be calculated by the following formula A:

$$A ( CFG ) = 1000 \frac{\begin{matrix}\sum ( pphm ( M {2}^{′} ) / Mw ( M {2}^{′} ) * n ) + \\ \sum ( pphm ( {Cm}^{′} ) / Mw ( {Cm}^{′} ) ) * k )\end{matrix}}{100 + \sum pphm ( C )} \qquad ( A )$$

where
A(CFG) is the amount of functional groups CFG in mol/kg;
M2′ is a monomer M2′ as defined above having n functional groups CFG which are located between the ethylenically unsaturated double bonds of M2′;
Mw(M2′) is the molecular weight of the monomer M2′;
n is the number of groups functional CFG in the monomers M2′ which are located between the ethylenically unsaturated double bonds of M2′;
pphm(M2′) is the amount of monomers M2′ in pphm;
Cm′ is a chain transfer compound Cm′ as defined herein where the functional groups CTG are connected by a spacer group which comprises at least one functional group CFG;
Mw(Cm′) is the molecular weight of the chain transfer compound Cm′;
k is the number of functional groups CFG in the chain transfer compound Cm′ which are comprised by the spacer group connecting the CTG groups of the chain transfer compound Cm′;
pphm(Cm′) is the amount of chain transfer compounds Cm′ in pphm;
pphm(C) is the total amount of chain transfer compounds C in pphm.

The hydrolytically cleavable functional groups CFG, hereinafter also referred to as cleavable functional groups CFG, functional groups CFG or CFG groups, respectively, may be cleavable by hydrolysis (hydrolytically cleavable). Here, hydrolytically cleavable means that the functional group is cleavable by water, e. g. by action of water and alkali and/or by hydrolytic enzymes in the presence of water. Suitable enzymes for this purpose include enzymes which catalyse the hydrolysis of ester, amide or anhydride groups, e. g. esterases, such as lipases, phosphatases and sulfatases, peptidases, amidases, including ureases, and pyrophosphatases. Suitable hydrolytically cleavable functional groups CFG include —C(O)O—, —C(O)NH—, —C(O)S—, —C(O)NHC(O)—, —S(O)₂O—, —OC(O)NH—, —NHC(O)NH—, —SC(O)NH— and combinations thereof. In the aforementioned functional groups the symbol “-” indicates one single bond.

Preference is given to hydrolytically cleavable functional groups CFG which are cleavable by aqueous alkali. Cleavable by aqueous alkali means that the functional group is cleavable by a 10% by weight aqueous solution of potassium hydroxide at 22° C. Such preferred groups include —C(O)O—, —C(O)NH—, —C(O)S—, —C(O)NHC(O)—. Most preference is given to —C(O)O—.

Therefore, the CFG groups interrupting the polymer carbon chain of the polymer P preferably comprise CFG groups selected from —C(O)O—, —C(O)NH—, —C(O)S—, —C(O)NHC(O)— and combinations thereof. Of course, the polymer P may comprise further cleavable functional groups CFG′ within its carbon chain. However, the amount of said further CFG′ groups will typically not exceed the amount of the functional groups CFG.

Particularly preferred polymers P comprise —C(O)O— groups as cleavable functional groups CFG within the carbon chain of the polymer P. Of course, the polymer P may comprise further cleavable functional groups CFG other than —C(O)O— within its carbon chain, such as —C(O)NH—, —C(O)S— or —C(O)NHC(O)—. However, the amount of said further CFG groups will typically not exceed the amount of the —C(O)O— groups. In particular the amount of —C(O)O— groups within the carbon chain of the polymer P is typically in the range of 0.1 to 20 mol·kg⁻¹, in particular in the range of 0.2 to 10 mol·kg⁻¹ and especially in the range of 0.3 to 8 mol·kg⁻¹ or 0.5 to 6 mol·kg⁻¹ of the polymer P.

Principally, any chain transfer compound C, which is also called regulator, molecular weight regulator or chain regulator, can be used in the emulsion polymerization of the monomers M. These chain transfer compounds have at least one functional group which is capable of providing a chain transfer during polymerization of the monomers M. These functional groups, which are herein also referred to as functional groups CTG or CTG groups, respectively, have a weak bond, which can be cleaved radically, whereby one radical is transferred to the carbon chain growing by polymerization of the monomers M, thus terminating its growth, while the other radical may initiate a further polymerization reaction. Typical CTG groups are mercapto groups, i. e. SH groups, which may be bound to aliphatic or aromatic carbons, CH groups, where the carbon atom is substituted by 2 or 3 electron-withdrawing groups, such as chlorine, bromine or phenyl, and OH groups attached to an aromatic carbon atom. Preference is given to mercapto groups (SH groups) as CTG groups.

Preference is given to chain transfer compounds C having at least two CTG groups, in particular m CTG groups, where m is integer of at least two, e. g. 2, 3, 4, 5 or 6, hereinafter also named chain transfer compound Cm. Particular preference is given to chain transfer compounds C having at least two SH groups, in particular m SH groups, where m is 2, 3, 4, 5 or 6, in particular 2, 3 or 4, hereinafter also named chain transfer compound CmSH, and especially 2 SH groups (hereinafter chain transfer compounds C2SH) or 3 SH groups (hereinafter chain transfer compounds C3SH) and combinations of transfer compounds C2SH and transfer compounds C3SH. A chain transfer compound Cm having at least two CTG groups, in particular at least two mercapto groups, e. g. a chain transfer compound C2SH and/or a chain transfer compound C3SH, may be the sole chain transfer compound or it may be combined with one or more chain transfer compound C having only one CTG group, hereinafter termed C1 or, if the chain transfer compound has only 1 SH group, it is termed C1SH. Particular preference is given to chain transfer compounds Cm′ as defined above, which are in particular chain transfer compounds CmSH′ as defined above, with most preference given to chain transfer compounds C2SH′, C3SH′ and combinations thereof and combinations of chain transfer compounds C2SH′ and/or C3SH′ with a chain transfer compound C1SH.

Preference is given to aqueous polymer dispersions, which are obtainable by the polymerization of the monomers M and at least one chain transfer compound C, which comprises at least one chain transfer compound Cm, in particular at least one chain transfer compound CmSH. Particular preference is given to aqueous polymer dispersions, which are obtainable by the polymerization of the monomers M and at least one chain transfer compound C, which is selected from at least one chain transfer compound Cm, in particular from at least one chain transfer compound CmSH. Particular preference is also given to aqueous polymer dispersions, which are obtainable by the polymerization of the monomers M and at least one chain transfer compound C, which is a combination at least one chain transfer compound Cm and at least one monofunctional chain transfer compound C1, in particular a combination least one chain transfer compound CmSH, in particular CmSH′, and at least one monofunctional chain transfer compound C1SH.

Amongst the chain transfer compounds having at least 2 CTG groups, in particular at least SH groups, preference is given to those, where at least 2 of the CTG groups are connected by a spacer group comprising at least one, e. g. 1, 2, 3 or 4 cleavable functional group(s) CFG, where the groups CFG are as defined above and preferably selected from —C(O)O—, —C(O)NH—, —C(O)S—, —C(O)NHC(O)— and where the cleavable functional group is especially —C(O)O—. As mentioned above, these chain transfer compounds are also referred to as chain transfer compounds Cm′.

The spacer group in the chain transfer compound C may be any bi- or polyvalent organic radical which has at least 2 carbon atoms which bear a CTG group, in particular a SH group, where the bi- or polyvalent organic includes at least on cleavable functional group located between the carbon atoms which bear the CTG groups. In these preferred chain transfer compounds, the spacer group typically has 2 to 40 carbon atoms, in particular 2 to 20 carbon atoms and at least 2 heteroatoms, e. g. 2 to 10 heteroatoms, in particular 2 to 6 heteroatoms, stemming from the cleavable functional group(s) CFG and optionally 0 to 10 further heteroatoms, which are not part of a CFG group.

The spacer group in the chain transfer compound C is typically selected from multivalent, e. g. 2-, 3-, 4-, 5- or 6-valent, aliphatic radicals, heteroaliphatic radicals, cycloaliphatic radicals, aliphatic-cycloaliphatic radicals, aliphatic-heterocycloaliphatic radicals, aromatic radicals and araliphatic radicals, with preference given to aliphatic radicals, heteroaliphatic radicals, cycloaliphatic radicals, aliphatic-cycloaliphatic radicals, and aliphatic-heterocycloaliphatic radicals.

Here and in the context of the definition of SP¹, SP², SP³ and SP⁴ the term “aliphatic radical” refers to multivalent linear or branched alkyl radicals as described above, where one or more CH₂ groups of alkyl may be replaced by C═O.

Here and in the context of the definition of SP¹, SP², SP³ and SP⁴ the term “aliphatic radical” refers to multivalent linear or branched alkyl radicals as described above, where one or more of the CH₂ or CH groups of the alkyl radical, which are not adjacent, are replaced by heteroatoms selected from O, S and N and where one or more CH₂ groups may be replaced by C═O. In the heteroaliphatic radicals the heteroatoms may also be part of a group CFG.

Here and in the context of the definition of SP¹, SP², SP³ and SP⁴ the term “cycloaliphatic radical” refers to multivalent cycloalkyl radicals as described above, where one or more, e. g. 1, 2 or 3, CH₂ groups of cycloalkyl may be replaced by C═O.

Here and in the context of the definition of SP¹, SP², SP³ and SP⁴ the term “heterocycloaliphatic radical” refers to multivalent cycloalkyl radicals as described above, where at least 1, e. g. 1, 2 or 3, of the CH₂ or CH groups of the cylcoaliphatic radical, which are not adjacent, is replaced by a heteroatom selected from O, S and N and where one or more, e. g. 1, 2 or 3, CH₂ groups may be replaced by C═O.

Here and in the context of the definition of SP¹, SP², SP³ and SP⁴ the term “aromatic radical” refers to multivalent radicals formed by a monocyclic or fused polycyclic aromatic ring, such as a benzene or naphthalene ring.

Here and in the context of the definition of SP¹, SP², SP³ and SP⁴ the term “aliphatic-cycloaliphatic radical” refers to multivalent radicals formed by at least one, e. g. 1, 2, 3, 4 or 5 alkylene radicals and at least one, e.g. 1 or 2 cycloaliphatic radicals as described herein, where one or more, e. g. 1, 2 or 3, CH₂ groups of alkylene may be replaced by C═O.

Here and in the context of the definition of SP¹, SP², SP³ and SP⁴ the term “aliphatic-heterocycloaliphatic radical” refers to multivalent radicals formed by at least one, e. g. 1, 2, 3, 4 or 5 alkylene radicals and at least one, e.g. 1 or 2 heterocycloaliphatic radicals as described herein, where one or more, e. g. 1, 2 or 3, CH₂ groups of alkylene may be replaced by C═O.

Here and in the context of the definition of SP¹, SP², SP³ and SP⁴ the term “aliphatic-aromatic radical” refers to multivalent radicals formed by at least one, e. g. 1, 2, 3, 4 or 5 alkylene radicals and at least one, e.g. 1 or 2 aromatic radicals as described herein, where one or more, e. g. 1, 2 or 3, CH₂ groups of alkylene may be replaced by C═O.

Preferred chain transfer compounds CmSH can be described by the formulae (C-1) and (C-2):

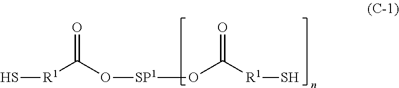

where
n is an integer from 1 to 5, in particular 1, 2 or 3 and especially 1 or 2,
R¹ is C₁-C₆ alkandiyl, in particular, CH₂, CH₂CH₂, CH₂CH₂CH₂ and
SP¹ is a n+1 valent organic radical, in particular a 2, 3 or 4 valent organic radical, having 2 to 40 carbon atoms, in particular 2 to 20 carbon atoms, and 0 to 12 heteroatoms, in particular 0 to 6 heteroatoms, where the heteroatoms are selected from the group consisting of O, N and S;

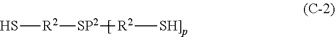

where
p is an integer from 1 to 5,
R² is C₁-C₆ alkandiyl, in particular, CH₂, CH₂CH₂, CH₂CH₂CH₂ and
SP² is a single bond or p+1 valent organic radical, in particular a 2, 3 or 4 valent organic radical, having 1 to 40 carbon atoms, in particular 2 to 20 carbon atoms, and 0 to 12 heteroatoms, in particular 0 to 6 heteroatoms, where the heteroatoms are selected from the group consisting of O, N and S.

SP¹ and SP² are generally aliphatic radicals, heteroaliphatic radicals, cycloaliphatic radicals, aliphatic-cycloaliphatic radicals, aliphatic-heterocycloaliphatic radicals, aromatic radicals and araliphatic radicals, with preference given to aliphatic radicals, heteroaliphatic radicals, cycloaliphatic radicals, aliphatic-cycloaliphatic radicals and aliphatic-heterocycloaliphatic radicals. SP¹ and SP² generally do not have ethylenically unsaturated double bonds other than those of the aromatic part of the araliphatic radical.

Aliphatic radicals SP¹ and SP² are n+1 valent or p+1 valent aliphatic radicals as described above.

Heteroaliphatic radicals SP¹ and SP² are n+1 valent or p+1 valent heteroaliphatic radicals as described above.

Cycloaliphatic radicals SP¹ and SP² are n+1 valent or p+1 valent cycloaliphatic radicals as described above.

Heterocycloaliphatic radicals SP¹ and SP² are n+1 valent or p+1 valent heterocycloaliphatic radicals as described above.

Aromatic radicals SP¹ and SP² are n+1 valent or p+1 valent aromatic radicals formed by a monocyclic or fused polycyclic aromatic ring, such as a benzene or naphthalene ring.

Aliphatic-cycloaliphatic radicals SP¹ and SP² are n+1 valent or p+1 valent radicals formed by at least one alkylene radical and at least one, e.g. 1 or 2 cycloaliphatic radicals as described herein, where one or more, e. g. 1, 2 or 3, CH₂ groups of alkylene may be replaced by C═O.

Aliphatic-heterocycloaliphatic radicals SP¹ and SP² are n+1 valent or p+1 valent radicals formed by at least one alkylene radical and at least one, e.g. 1 or 2 heterocycloaliphatic radicals as described herein, where one or more, e. g. 1, 2 or 3, CH₂ groups of alkylene may be replaced by C═O.

Aliphatic-aromatic radicals SP¹ and SP² are n+1 valent or p+1 valent radicals formed by at least one alkylene radical and at least one, e.g. 1 or 2 aromatic radicals as described herein, where one or more, e. g. 1, 2 or 3, CH₂ groups of alkylene may be replaced by C═O.

Particular preferred chain transfer compounds CmSH can be described by the formulae (C-1)

Preferred examples of chain transfer agents C of the formula C-1 include but are not limited to ethylene glycol bis(3-mercaptopropionate), pentaerythritol tetrakis(3-mercaptopropionate), trimethylolpropane tris(3-mercaptopropionate), pentaerythritol tetrakis(3-mercaptobutyrate), pentaerythritol tetrakis(mercaptoethyl-polyoxyethylene), reaction products of isophorone diisocyanate (=3-isocyanatomethyl-3,5,5-trimethylcyclohexyl isocyanate) and trimethylolpropane tris(3-mercaptopropionate), pentaerythritol tetrakis(3-mercaptobutyrate-polyoxyethylene), tris[2-(3-mercaptopropionyloxy)ethyl]isocyanurate, 1,6-hexanediol bis(3-mercaptopropionate), 1,4-cyclohexanediol bis(3-mercaptopropionate), 2,2-bis(4-hydroxycyclohexyl)-propane bis(3-mercaptopropionate).

Preferred examples of chain transfer compounds C of the formula C-2 include but are not limited poly(ethyleneglycol) dithiol, bis(2-mercaptoethyl) sulfone, 4-(mercaptomethyl)-3,6-dithia-1,8-octanedithiol.

Preferred examples of chain transfer compounds C having only 1 SH group include buta are not limited to n-dodecyl mercaptan, tert-dodecyl mercaptan, 2-ethylhexyl 3-mercaptopropionate, isooctyl 3-mercaptopropionate, 2-mercapto acetic acid, 3-mercapto propionic acid, butyl 2-mercaptoacetate, butyl 3-mercaptopropionate 2-ethylhexyl 2-mercaptoacetate and isooctyl 2-mercaptoacetate.

The total amount of chain transfer compounds C is typically in the range of 1 to 25% by weight, in particular in the range of 2 to 22% by weight and especially in the range of 2.5 to 20% by weight, based on the total weight of monomers M+chain transfer compound C.

According to the invention the monomers M which, together with the chain transfer agent C, form the polymer P of the polymer dispersion, comprise at least one multiethylenically unsaturated monomer M2 as defined herein. The term “multiethylenically unsaturated” as used herein is understood that the monomer M2 has at least 2, e. g. 2, 3, 4, 5 or 6, in particular 2, 3 or 4 ethylenically unsaturated double bonds, which are not conjugated. Thus, in the polymerization of the monomers M, the virtually all, i. e. at least 90% of the ethylenically unsaturated double bonds of the monomers M2 will polymerize and result in a crosslinking or at least in a branching of the polymer P.

Preference is given to monomers M2 which have at least one cleavable functional group CFG, in particular at least one —C(O)O— group. More preference is given to monomers M2 which have a cleavable functional group CFG which is a —C(O)O— group, and wherein the ethylenically unsaturated double bonds and the functional groups CFG in the monomers M2 are combined to form an acrylate or methacrylate group or an allyl group. Particular preference is given to monomers M2 wherein at least one of the ethylenically unsaturated double bonds and the functional groups CFG in the monomers M2 are combined to form an acrylate or methacrylate group while the other ethylenically double bond of M2 are acrylate, methacrylate or allyl.

Preference is given to monomers M2 which have at least one cleavable functional group CFG, in particular at least one —C(O)O— group, where the ethylenically unsaturated double bonds of the monomer M2 are connected by a spacer group which comprises at least one functional group CFG, in particular a —C(O)O— group.

Particular preference is given to monomers M2 which have a cleavable functional group CFG which is a —C(O)O— group, and wherein the ethylenically unsaturated double bonds and the functional groups CFG in the monomers M2 are combined to form an acrylate or methacrylate group or an allyl group which are connected by a spacer group which may comprise one or more functional group CFG.

If present, the spacer group in the monomers M2 may be any bi- or polyvalent organic which includes at least on cleavable functional group CFG located between the ethylenically unsaturated double bonds of the monomer M2 and which may be part of an acrylate or methacrylate group. In these preferred monomers M2, the spacer group typically has 2 to 40 carbon atoms, in particular 2 to 20 carbon atoms and at least 2 heteroatoms, e. g. 2 to 10 heteroatoms, in particular 2 to 6 heteroatoms, stemming from the cleavable functional group(s) CFG and optionally 0 to 10 further heteroatoms, which are not part of a CFG group.

If present, the spacer group in the monomers M2 is typically selected from multivalent, e. g. 2-, 3-, 4-, 5- or 6-valent, aliphatic radicals, heteroaliphatic radicals, cycloaliphatic radicals, aliphatic-cycloaliphatic radicals, aliphatic-heterocycloaliphatic radicals, aromatic radicals and araliphatic radicals, with preference given to aliphatic radicals, heteroaliphatic radicals, cycloaliphatic radicals, aliphatic-cycloaliphatic radicals, and aliphatic-heterocycloaliphatic radicals.

Preferred monomers M2 can be described by the formulae (M2-1) and (M2-2):

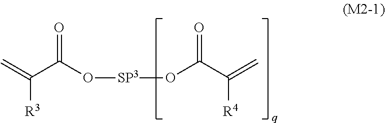

where in formula M2-1
q is an integer from 1 to 5, in particular 1, 2 or 3 and especially 1 or 2,
R³ is H or methyl,
R⁴ is H or methyl and
SP³ is a q+1 valent organic radical, in particular a 2, 3 or 4 valent organic radical, having 2 to 40 carbon atoms, in particular 2 to 20 carbon atoms, and 0 to 12 heteroatoms, in particular 0 to 6 heteroatoms, where the heteroatoms are selected from the group consisting of O, N and S;

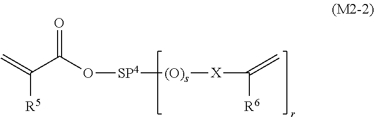

and where in formula M2-1
r is an integer from 1 to 5,
s is 0 or 1,
X is a single bond or CH₂,
R⁵ is H or methyl,
R⁶ is H or methyl and
SP⁴ is a r+1 valent organic radical, in particular a 2, 3 or 4 valent organic radical, having 2 to 40 carbon atoms, in particular 2 to 20 carbon atoms, and 0 to 12 heteroatoms, in particular 0 to 6 heteroatoms, where the heteroatoms are selected from the group consisting of 0, N and Sor, if q is 1, SP⁴ may also be a single bond, provided that s is 1, if SP⁴ is a single bond.

Aliphatic radicals SP³ and SP⁴ are q+1 valent or r+1 valent aliphatic radicals as described above.

Heteroaliphatic radicals SP³ and SP⁴ are q+1 valent or r+1 valent heteroaliphatic radicals as described above.

Cycloaliphatic radicals SP³ and SP⁴ are q+1 valent or r+1 valent cycloaliphatic radicals as described above.

Heterocycloaliphatic radicals SP³ and SP⁴ are q+1 valent or r+1 valent heterocycloaliphatic radicals as described above.

Aromatic radicals SP³ and SP⁴ are q+1 valent or r+1 valent aromatic radicals formed by a monocyclic or fused polycyclic aromatic ring, such as a benzene or naphthalene ring.

Aliphatic-cycloaliphatic radicals SP³ and SP⁴ are q+1 valent or r+1 valent radicals formed by at least one alkylene radical and at least one, e.g. 1 or 2 cycloaliphatic radicals as described herein, where one or more, e. g. 1, 2 or 3, CH₂ groups of alkylene may be replaced by C═O.

Aliphatic-heterocycloaliphatic radicals SP³ and SP⁴ are q+1 valent or r+1 valent radicals formed by at least one alkylene radical and at least one, e.g. 1 or 2 heterocycloaliphatic radicals as described herein, where one or more, e. g. 1, 2 or 3, CH₂ groups of alkylene may be replaced by C═O.

Aliphatic-aromatic radicals SP³ and SP⁴ are q+1 valent or r+1 valent radicals formed by at least one alkylene radical and at least one, e.g. 1 or 2 aromatic radicals as described herein, where one or more, e. g. 1, 2 or 3, CH₂ groups of alkylene may be replaced by C═O.

Preferred examples of monomers M2 of the formula M2-1 include but are not limited to ethylene glycol diacrylate, ethylene glycol dimethacrylate, trimethylolpropane triacrylate, trimethylolpropane trimethacrylate, trimethylolpropane ethoxylate triacrylate, trimethylolpropane ethoxylate trimethacrylate, pentaerythritol triacrylate, pentaerythritol trimethacrylate, pentaerythritol tetraacrylate, pentaerythritol tetramethacrylate, tetra(ethylene glycol) diacrylate, tetra(ethylene glycol) dimethacrylate, di(ethylene glycol) diacrylate, di(ethylene glycol) dimethacrylate, 1,3-butandiol diacrylate, 1,3-butandiol dimethacrylate, 1,4-butandiol diacrylate, 1,4-butandiol dimethacrylate, 1,6-hexandiol diacrylate, 1,6-hexandiol dimethacrylate, poly(ethylene glycol) diacrylate, poly(ethylene glycol) dimethacrylate, 1,1-bis(2-acryloyloxy ethoxy)-[4-methoxy-phenyl]methane, 1,1-bis(2-methacryloyloxy ethoxy)[4-methoxy-phenyl]methane, bis(2-acryloyloxy ethyl) disulfide and bis(2-methacryloyloxy ethyl) disulfide.

Preferred examples of monomers M2 of the formula M2-2 include but are not limited to allyl acrylate, 2-methylallyl acrylate, vinyl acrylate, 2-(vinyloxy)ethyl acrylate, allyl methacrylate, 2-methylallyl methacrylate, vinyl methacrylate, 2-(vinyloxy)ethyl methacrylate.

It is apparent that monomers M2 can also be used in combination, e. g. as combinations of two or more monomers M2-1, as combinations of two or more monomers M2-2, or as combinations of one or more monomers M2-1 with one or more monomers M2-2.

The total amount of monomers M2-2 is typically in the range of 2 to 25% by weight, in particular in the range of 3 to 22% by weight and especially in the range of 5 to 20% by weight, based on the total weight of monomers M+chain transfer compound C.

The total amount of chain transfer agent C and monomer M2, i. e. the total amount of M2+C, is typically in the range of 3 to 40% by weight, in particular in the range of 5 to 30% by weight and especially in the range of 7.5 to 25% by weight, based on the total weight of monomers M+chain transfer compound C.

In preferred polymer dispersions the polymer P is obtainable from the monomers M and the chain transfer agent, where the relative amount of the chain transfer agent C and the monomer M2 is chosen such that the molar ratio of the total amount of functional groups CTG of the chain transfer agent C and the total amount of ethylenically unsaturated double bonds of the monomer M2 is in the range of 10:1 to 1:6, in particular in the range of 5:1 to 1:5.

As mentioned before, preference is given to aqueous polymer dispersions of polymers P obtainable by emulsion polymerization of ethylenically unsaturated monomers M and chain transfer compound C, where the ethylenically unsaturated double bonds of the monomer M2 comprised in the monomers M1 are connected by a spacer group which comprises at least one functional group CFG which is not a chain transfer group and which is in particular at least one —C(O)O— group, and/or where the chain transfer compound C has at least 2 functional groups CTG which are capable of providing a chain transfer during polymerization of the monomers M, and where the CTG groups are in particular SH, wherein the at least 2 functional groups CTG are connected by a spacer group which comprises at least one functional group CFG, which is in particular a —C(O)O— group. Amongst these polymer dispersions particular preference is given to those, where in the monomers M2 at least one of the —C(O)O— groups together with an ethylenically unsaturated double bond of the monomer M2 forms an acrylate or methacrylate group. Amongst these polymer dispersions particular preference is given to those, where the monomers M2 are selected from monomers of the formula M2-1 and M2-2 and combinations thereof. Amongst these polymer dispersions particular preference is given to those, where the chain transfer compound is selected from compounds of the formula C-1.

More preference is given to polymers P obtainable by emulsion polymerization of ethylenically unsaturated monomers M and chain transfer compound C, where the ethylenically unsaturated double bonds of the monomer M2 comprised in the monomers M1 are connected by a spacer group which comprises at least one functional group CFG which is in particular at least one —C(O)O— group and where the chain transfer compound C has at least 2 functional groups CTG which are capable of providing a chain transfer during polymerization of the monomers M, and where the CTG groups are in particular SH, wherein the at least 2 functional groups CTG are connected by a spacer group which comprises at least one functional group CFG, which is in particular a —C(O)O— group. Amongst these polymer dispersions particular preference is given to those, where in the monomers M2 at least one of the —C(O)O— groups together with an ethylenically unsaturated double bond of the monomer M2 forms an acrylate or methacrylate group. Amongst these polymer dispersions more preference is given to those, where the monomers M2 are selected from monomers of the formula M2-1 and M2-2 and combinations thereof and where the chain transfer compound is selected from compounds of the formula C-1.

The monomers M which form the carbon chain of the polymer P in the aqueous polymer dispersion of the present invention comprise one or more monoethylenically unsaturated monomers M1. Typically, the monomers M1 comprise at least one monomer M1.1 which have a solubility in water of not more than 60 g/L at 20° C. and 1 bar and which is in particular selected from the group of alkyl acrylates, alkyl methacrylates, cycloalkyl acrylates, cycloalkyl methacrylates, vinylesters of saturated aliphatic acids, monovinyl aromatic compounds and mono-olefins and conjugated diolefins. It should be noted that conjugated diolefins will not result in considerable crosslinking in an emulsion polymerization. Rather, typically only one of their two ethylenically unsaturated bonds will polymerize.

Suitable monomers M1.1 are in particular C₁-C₂₀-alkyl esters of acrylic acid, C₅-C₂₀-cycloalkyl esters of acrylic acid, C₁-C₂₀-alkyl esters of methacrylic acid, C₅-C₂₀-cycloalkyl esters of methacrylic acid, acrylonitrile, monovinyl aromatic monomers and mixtures thereof.

Suitable C₁-C₂₀-alkyl esters of acrylic acid include, but are not limited to methyl acrylate, ethyl acrylate, n-propyl acrylate, isopropyl acrylate, n-butyl acrylate, secbutyl acrylate, isobutyl acrylate, tert.-butyl acrylate n-pentyl acrylate, 2-pentyl acrylate, isopentyl acrylate, n-hexyl acrylate, n-octyl acrylate, 2-octyl acrylate, 2-ethylhexyl acrylate, n-decyl acrylate, isodecyl acrylate, 2-propylheptyl acrylate, lauryl acrylate, C₁₂/C₁₄-alkyl acrylate, C₁₂-C₁₅-alkyl acrylate, isotridecyl acrylate, C₁₆/C₁₈-alkyl acrylate and stearyl acrylate.

Suitable C₁-C₂₀-alkyl esters of methacrylic acid include, but are not limited to methyl methacrylate, ethyl methacrylate, n-propyl methacrylate, isopropyl methacrylate, n-butyl methacrylate, sec-butyl methacrylate, isobutyl methacrylate, tert-butyl methacrylate, n-pentyl methacrylate, 2-pentyl methacrylate, isopentyl methacrylate, n-hexyl methacrylate, n-octyl methacrylate, 2-octyl methacrylate, 2-ethylhexyl methacrylate, n-decyl methacrylate, isodecyl methacrylate, 2-propylheptyl methacrylate, lauryl methacrylate, C₁₂/C₁₄-alkyl methacrylate, C₁₂-C₁₅-alkyl methacrylate, isotridecyl methacrylate, C₁₆/C₁₈-alkyl methacrylate and stearyl methacrylate.

Suitable C₅-C₂₀-cycloalkyl esters of acrylic acid include, but are not limited to cyclopentyl acrylate, cyclohexyl acrylate, norbornyl acrylate and isobornyl acrylate.

Suitable C₅-C₂₀-cycloalkyl esters of methacrylic acid include, but are not limited to cyclopentyl methacrylate, cyclohexyl methacrylate, norbornyl methacrylate and isobornyl methacrylate.

The monomers M1.1 may also comprise monovinyl aromatic monomers, such as styrene.

The monomers M1.1 may also comprise acrylonitrile.

The monomers M1.1 may also comprise vinylesters of saturated fatty acids, which are vinylesters, where the fatty acid has 2 to 12 carbon atoms. Examples include vinyl acetate, vinyl propionate, vinyl laurate, vinyl esters of alpha-branched carboxylic acids having 8 to 11 carbon atoms such as VeoVa®EH, VeoVa®9 or VeoVa®10 (tradenames of Resolution).

In particular, the monomers M1.1 comprise at least 30% by weight, in particular at least 40% by weight, based on the total weight of the monomers M1.1 of at least one monomer M1.1 which is selected from the group consisting of C₁-C₂₀-alkyl esters of acrylic acid, C₅-C₂₀-cycloalkyl esters of acrylic acid, C₁-C₂₀-alkyl esters of methacrylic acid, C₅-C₂₀-cycloalkyl esters of methacrylic acid, and which is in particular selected from the group consisting of C₂-C₁₂-alkyl esters of acrylic acid, C₅-C₁₀-cycloalkyl esters of acrylic acid, C₁-C₄-alkyl esters of methacrylic acid, C₅-C₁₀-cycloalkyl esters of methacrylic acid and combinations thereof.

The total amount of monomers M1.1 is typically in the range of 85.0 to 99.9% by weight in particular in the range of 90.0 to 99.8% by weight or 90.0 to 99.7% by weight and especially in the range of 90.0 to 99.5% by weight or 90.0 to 99.0% by weight, based on the total weight of monomers M1.

In a preferred group 1 of embodiments, the monomers M1.1 comprise at least one monomer M1.1a whose homopolymer has a glass transition temperature of more than 50° C., e.g. in the range of >50 to 200° C. and at least one monomer M1.1b whose homopolymer has a glass transition temperature of not more than 50° C., e.g. in the range of −100 to +50° C. The glass transition temperatures Tg of the homopolymers of monomers M1 are well known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004 and in publicly available database, e.g. from “Polymer Properties Database”, Crow® 2015-2021, https://polymerdatabase.com/polymer%20physics/Polymer%20Tg%20C.html.

Apart from that the glass transition temperature Tg of the homopolymers of the monomers M1.1 as referred to herein can be determined experimentally by the differential scanning calorimetry (DSC) method according to ISO 11357-2:2013, preferably with sample preparation according to ISO 16805:2003.

Suitable monomers M1.1a are in particular
monovinylaromatic monomers, such as styrene,
C₁-C₄-alkyl esters of methacrylic acid, such as methyl methacrylate, ethyl methacrylate, n-propyl methacrylate, isopropyl methacrylate, n-butyl methacrylate, sec-butyl methacrylate, isobutyl methacrylate, tert-butyl methacrylate,
C₅-C₁₀ cycloalkyl esters of methacrylic acid, such as cyclopentyl methacrylate, cyclohexyl methacrylate, norbornyl methacrylate and isobornyl methacrylate,
acrylonitrile
   and combinations thereof.

If the monomers M1.1a comprise acrylonitrile, the monomers M1.1a preferably comprise at last one further monomer M1.1a which is different from acrylonitrile. Preferably, the total amount of acrylonitrile, if present, will not exceed 50% by weight, based on the total amount of the monomers M1.1a.

Suitable monomers M1.1b are in particular C₂-C₁₂-alkyl ester of acrylic acid, such as ethyl acrylate, n-propyl acrylate, isopropyl acrylate, n-butyl acrylate, sec-butyl acrylate, isobutyl acrylate, n-pentyl acrylate, 2-pentyl acrylate, isopentyl acrylate, n-hexyl acrylate, n-octyl acrylate, 2-octyl acrylate, 2-ethylhexyl acrylate, n-decyl acrylate, isodecyl acrylate, 2-propylheptyl acrylate and lauryl acrylate and combinations thereof. Particular preference is given to monomers M1.1b, which are selected from the group consisting of n-butyl acrylate, isobutyl acrylate, 2-octyl acrylate and 2-ethylhexylacrylate and combinations thereof.

In a particular group 2 of embodiments, the monomers M1 comprise 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of a combination of at least one monomer M1.1a and at least one monomer M1.1b, more particularly a combination of
at least one monomer M1.1a, which is selected from C₁-C₄-alkyl esters of methacrylic acid, in particular methyl methacrylate, monovinyl aromatic hydrocarbon monomers, acrylonitrile and combinations thereof; and,
and at least one monomer M1.1b which is selected from C₂-C₁₂-alkyl esters of acrylic acid, in particular from the group consisting of n-butyl acrylate, isobutyl acrylate, 2-octyl acrylate and 2-ethylhexylacrylate and combinations thereof.

In a further particular subgroup 2a of group 2 of embodiments, the monomers M1 comprise 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of a combination of at least one monomer M1.1a and at least one monomer M1.1b, more particularly a combination of
at least one monomer M1.1a, which is selected from methyl methacrylate, styrene, combinations of styrene and methyl methacrylate, combinations of styrene and acrylonitrile, combinations of methyl methacrylate and acrylonitrile and combinations of styrene, methyl methacrylate and acrylonitrile;
and at least one monomer M1.1b which is selected from C₂-C₁₂-alkyl esters of acrylic acid, in particular from the group consisting of n-butyl acrylate, isobutyl acrylate, 2-octyl acrylate and 2-ethylhexylacrylate and combinations thereof.

In the aforementioned combinations of monomers M1.1a and M1.1b is in particular in the weight ratio of the total amount of monomers M1.1a to the total amount of monomers M1.1b, hereinafter also referred to as weight ratio M1.1a.M1.1b is preferably in the range of 1:20 to 5:1, in particular in the range of 1:15 to 4:1 and especially in the range of 1:10 to 3:1, in particular, if the polymer P is used as a binder in coating compositions.

The monomers M1 may contain one or more further monoethylenically unsaturated monomers which are different from the monomers M1.1. The further monoethylenically unsaturated monomers include, e. g.
monoethylenically unsaturated monomers M1.2 bearing at least one acid group selected from SO₃H, OSO₃H, PO₃H₂, OPO₃H₂ and CO₂H, where the acid group may be present in its protonated form or in its salt form, in particular in the form of their alkalimetal salt or an ammonium salt; and
monoethylenically unsaturated monomers M1.3 which are non-ionic and which have a solubility in deionized water of more than 60 g/L, in particular at least 80 g/L or at least 100 g/L at 20° C. and 1 bar or which are completely miscible with water under these conditions.

Suitable monomers M1.2 include, but are not limited to
monoethylenically unsaturated monocarboxylic acids having 3 to 6 carbon atoms, such as acrylic acid, methacrylic acid, crotonic acid, 2-ethylpropenoic acid, 2-propylpropenoic acid, 2-acryloxyacetic acid and 2-methacryloxyacetic acid;
monoethylenically unsaturated dicarboxylic acids having 4 to 6 carbon atoms, such as itaconic acid, citraconic acid, maleic acid and fumaric acid;
semi-esters of monoethylenically unsaturated dicarboxylic acids having 4 to 6 carbon atoms, with C₁-C₄ alkanols, such as methanol or ethanol, such as semi-esters of itaconic acid, citraconic acid, maleic acid or fumaric acid with methanol or ethanol;
monoethylenically unsaturated sulfonic acids, such as vinylsulfonic acid, allylsulfonic acid, styrenesulfonic acid, and monomers of the formula (M1.2a)
monoethylenically unsaturated phosphonic acids such as vinylphosphonic acid, allylphosphonic acid, styrenephosphonic acid and 3-methacryloxypropane phosphonic acid,
monoethylenically unsaturated phosphoric acids such as monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, e. g. monomers of the formula (M1.2b) as described below.

The aforementioned monomers M1.2 can be present in their acidic form or in the form of their salts, in particular in the form of their alkalimetal salts or ammonium salts.

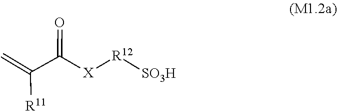

In formula M1.2a, the variables have the following meanings:
X is NH or O,
R¹¹ is hydrogen or methyl,
R¹² is selected from the group consisting of C₂-C₆-alkylene, phenylene, phenyl-C₁-C₂-alkylene and C₁-C₂-alkylphenylene and where R¹² is in particular selected from the group consisting of C₂-C₆-alkylene,
and the salts thereof, preferably the ammonium, sodium, potassium, magnesium and/or calcium salt thereof, especially the sodium or potassium salts thereof.

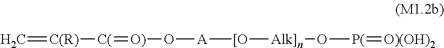

In formula M1.2b, the variables have the following meanings:
A is C₂-C₄-alkandiyl, in particular 1,2-ethanediyl, 1,3-propandiyl or 1,2-propandiyl,
Alk within the repeating unit [Alk-0], is identical or different and 1,2-ethanediyl or 1,2-propandiyl,
n is 0 or an integer from 1 to 20, in particular 0 or an integer from 2 to 10, and
R is hydrogen or methyl.

Examples of monomers of the formula M1.2a include 2-acrylamido-2-methylpropanesulfonic acid (AMPS), 2-methacrylamido-2-methylpropanesulfonic acid, 2-acrylamidobutanesulfonic acid, 3-acrylamido-3-methylbutanesulfonic acid, 2-acrylamido-2,4,4-trimethylpentanesulfonic acid, 2-methacrylamidobutanesulfonic acid, 3-methacrylamido-3-methylbutanesulfonic acid, 2-methacrylamido-2,4,4-trimethylpentanesulfonic acid, 2-sulfoethylacrylate, 3-sulfopropylacrylate, 2-sulfoethylmethacrylate, 3-sulfopropylmethacrylate and the salts thereof, in particular the ammonium, sodium, potassium, magnesium and/or calcium salt thereof, especially the sodium salt or potassium salt thereof.

Examples of monomers of the formula M1.2b include mono-methacryloxyethyl phosphate, mono-methacryloxypropyl phosphate, mono-methacryl(oxy-1,2-ethanediyl)₂₋₁₀ phosphate or mono-methacryl(oxy-1,2-propandiyl)₂₋₁₀ phosphate and mono-methacryl(oxy-1,2-ethanediyl)₂₋₁₀ phosphate, i.e. the monomers of formula (II) with A and Alk being 1,2-ethanediyl or 1,2-propanediyl, n being an integer from 2 to 10 and R being methyl, in particular in the form of the salts, such as the ammonium, sodium or potassium salts thereof.

Suitable nonionic monoethylenically unsaturated monomer M1.3 are e.g. those which have a functional group selected from hydroxyalkyl groups, in particular hydroxy-C₂-C₄-alkyl group, a polyethylene oxide group or an alkyl polyethyleneoxide group, a carboxamide group, urea groups and keto groups.

Examples for monomers M1.3 having a carboxamide group include, but are not limited to primary amides of monoethylenically unsaturated monocarboxylic acids having 3 to 6 carbon atoms, such as acrylamide and methacrylamide, and C₁-C₄-alkylamides of monoethylenically unsaturated monocarboxylic acids having 3 to 6 carbon atoms, such as N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide.

Examples for monomers M1.3 having a hydroxyalkyl group, in a particular hydroxy-C₂-C₄-alkyl group are the monoesters of a C₂-C₄-alkandiol with a monoethylenically unsaturated monocarboxylic acids having 3 to 6 carbon atoms, in particular with acrylic acid or methacrylic acid, such as hydroxyethyl acrylate, hydroxyethyl methacrylate, hydroxypropyl acrylate, hydroxypropyl methacrylate, hydroxybutyl acrylate and hydroxybutyl methacrylate.

Examples for monomers M1.3 having a urea group are the C₁-C₄-alkyl esters of acrylic acid or methacrylic acid and the N—C₁-C₄-alkyl amides of acrylic acid or methacrylic acid, where the C₁-C₄-alkyl group bears an urea group or a 2-oxoimidazolin group such as 2-(2-oxo-imidazolidin-1-yl)ethyl acrylate, 2-(2-oxo-imidazolidin-1-yl)ethyl methacrylate, which are also termed 2-ureido acrylate and 2-ureido methacrylate, respectively, N-(2-acryloxyethyl)urea, N-(2-methacryloxyethyl)urea, N-(2-(2-oxo-imidazolidin-1-yl)ethyl) acrylamide, N-(2-(2-oxo-imidazolidin-1-yl)ethyl) methacrylamide, as well as allyl or vinyl substituted ureas and allyl or vinyl substituted 2-oxoimidazolin compounds such as 1-allyl-2-oxoimidazolin, N-allyl urea and N-vinylurea.

Examples for monomers M1.3 having a keto group are the
i) C₂—C-oxoalkyl esters of acrylic acid or methacrylic acid and the N—C₂-C₈-oxoalkyl amides of acrylic acid or methacrylic acid, such as diacetoneacrylamide (DAAM), and diacetonemethacrylamide, and
ii) C₁-C₄-alkyl esters of acrylic acid or methacrylic acid and the N—C₁-C₄-alkyl amides of acrylic acid or methacrylic acid, where the C₁-C₄-alkyl group bears a 2-acetylacetoxy group of the formula O—C(═O)—CH₂—C(═O)—CH₃ (also termed acetoacetoxy group), such as acetoacetoxyethyl acrylate, acetoacetoxypropyl methacrylate, acetoacetoxybutyl methacrylate and 2-(acetoacetoxy)ethyl methacrylate.

Examples of monomers M1.3 having a polyethylene oxide group or an alkyl polyethyleneoxide group are in particular the monoacrylate esters and monomethacrylate esters of polyethyleneoxides, the monoacrylate esters and monomethacrylate esters of methylpolyethyleneoxides, the monoalllyl ethers and mono-but-3-enyl ethers of polyethyleneoxides and the monoalllyl ethers and mono-but-3-enyl ethers of methylpolyethyleneoxides, wherein the polyethyleneoxide and methylpolyethylene oxide radicals generally have on average 5 to 100, in particular 10 to 50 ethylenoxide repeating units. The amounts of said monomers having a polyethylene oxide group or an alkyl polyethyleneoxide group, if present, will generally not exceed 5 pphm and, if present, are typically present in an amount of 0.1 to 5% by weight, especially in an amount of 0.2 to 3% by weight, based on the total weight of monomers M1.

Monomers M1.2 and/or M1.3 are typically present in the monomers M1 as a combination with at least one monomer M1.1, in particular in combination with at least one preferred monomer M1.1. comprising at least 30% by weight, in particular at least 40% by weight, based on the total weight of the monomers M1.1 of at least one monomer M1.1 which is selected from the group consisting of C₁-C₂₀-alkyl esters of acrylic acid, C₅-C₂₀-cycloalkyl esters of acrylic acid, C₁-C₂₀-alkyl esters of methacrylic acid, C₅-C₂₀-cycloalkyl esters of methacrylic acid, and which is in particular selected from the group consisting of which is selected from the group consisting of C₂-C₁₀-alkyl esters of acrylic acid, C₅-C₁₀-cycloalkyl esters of acrylic acid, C₁-C₄-alkyl esters of methacrylic acid, C₅-C₁₀-cycloalkyl esters of methacrylic acid and combinations thereof.

Preferably, the monomers M comprise at least one monomer M1.2. The relative amount of the monoethylenically unsaturated monomers M1.2 is preferably in the range of 0.1 to 10% by weight, in particular in the range of 0.2 to 7% by weight and especially 0.3 to 5% by weight, based on the total weight of the monomers M1. The amount of monomers M1.3 is typically in the range of 0 to 10% by weight or 0.1 to 10% by weight, in particular in the range of 0 to 8% by weight or 0.2 to 8% by weight and especially in the range of 0 to 5% by weight or 0.5 to 5% by weight, based on the total weight of the monomers M1.

The total amount of monomers M1.2 and M1.3 is typically in the range of 0.1 to 15% by weight or 0.15 to 15% by weight, in particular in the range of 0.2 to 10% by weight or 0.3 to 10% by weight and especially in the range of 0.5 to 10% by weight or 1.0 to 10% by weight, based on the total weight of monomers M1.

The total amount of monomers M1 is typically in the range of 60 to 97% by weight, in particular 65 to 95% by weight and especially 65 to 92.5% by weight, based on the monomers M+chain transfer compound C.

In a particular group 3 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1, comprising in particular a combination of at least one monomer M1.1 and at least one monomer M1.2 as described herein and in particular a combination of at least one monomer M1.1a and M1.1b according to group 1 of embodiments, in particular according to group 2 or subgroup 2a of embodiments;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture.

In a particular group 4 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1 comprising in particular a combination of at least one monomer M1.1 and at least one monomer M1.2 as described herein and in particular a combination of at least one monomer M1.1a and M1.1b according to group 1 of embodiments, in particular according to group 2 or subgroup 2a of embodiments;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the ethylenically unsaturated double bonds of the monomer M2 are connected by a spacer group which comprises at least one functional group CFG, which is not a chain transfer group and/or where the chain transfer compound C has at least 2 functional groups CTG which are capable of providing a chain transfer during polymerization of the monomers M wherein the at least 2 functional groups CTG are connected by a spacer group which comprises at least one functional group CFG.

In a particular group 5 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1 comprising in particular a combination of at least one monomer M1.1 and at least one monomer M1.2 as described herein and in particular a combination of at least one monomer M1.1a and M1.1b according to group 1 of embodiments, in particular according to group 2 or subgroup 2a of embodiments;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the monomers M2 are selected from the monomers of the formulae M2-1 and M2-2 and/or where the chain transfer compound C has at least 2 SH groups.

In a particular group 6 of embodiments, the polymer P of the aqueous polymer dispersion of the present invention is formed from polymerized units of a mixture of the monomers M and the chain transfer agent C, where the mixture comprises
d) 60 to 97% by weight, in particular 65 to 95% by weight and especially 65 to 92.5% by weight of at least one monoethylenically unsaturated monomer M1 comprising in particular a combination of at least one monomer M1.1 and at least one monomer M1.2 as described herein and in particular a combination of at least one monomer M1.1a and M1.1b according to group 1 of embodiments, in particular according to group 2 or subgroup 2a of embodiments;
e) 2 to 25% by weight, in particular 3 to 22% by weight and especially 5 to 20% by weight of at least one multiethylenically unsaturated monomer M2;
f) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the monomers M2 are selected from the monomers of the formulae M2-1 and M2-2 and/or where the chain transfer compound C is of the formula C-1.

In a particular group 3.1 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1 comprising
   a.1) 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of at least one monomer M1.1, in particular a combination of at least one monomer M1.1a and at least one monomer M1.1b, in particular a combination according to group 2 or subgroup 2a of embodiments;
   a.2) 0.1 to 10% by weight, in particular in the range of 0.2 to 7% by weight and especially 0.3 to 5% by weight, based on the total weight of the monomers M1, of at least one monomer M1.2;
   a.3) 0 to 10% by weight or 0.1 to 10% by weight, in particular in the range of 0 to 8% by weight or 0.2 to 8% by weight and especially in the range of 0 to 5% by weight or 0.5 to 5% by weight, based on the total weight of the monomers M1, of one or more monomers M1.3;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture.

In a particular group 4.1 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1, comprising
   a.1) 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of at least one monomer M1.1, in particular a combination of at least one monomer M1.1a and at least one monomer M1.1b, in particular a combination according to group 2 or subgroup 2a of embodiments;
   a.2) 0.1 to 10% by weight, in particular in the range of 0.2 to 7% by weight and especially 0.3 to 5% by weight, based on the total weight of the monomers M1, of at least one monomer M1.2;
   a.3) 0 to 10% by weight or 0.1 to 10% by weight, in particular in the range of 0 to 8% by weight or 0.2 to 8% by weight and especially in the range of 0 to 5% by weight or 0.5 to 5% by weight, based on the total weight of the monomers M1, of one or more monomers M1.3;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the ethylenically unsaturated double bonds of the monomer M2 are connected by a spacer group which comprises at least one functional group CFG, which is not a chain transfer group and/or where the chain transfer compound C has at least 2 functional groups CTG which are capable of providing a chain transfer during polymerization of the monomers M wherein the at least 2 functional groups CTG are connected by a spacer group which comprises at least one functional group CFG.

In a particular group 5.1 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1; comprising
   a.1) 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of at least one monomer M1.1, in particular a combination of at least one monomer M1.1a and at least one monomer M1.1b, in particular a combination according to group 2 or subgroup 2a of embodiments;
   a.2) 0.1 to 10% by weight, in particular in the range of 0.2 to 7% by weight and especially 0.3 to 5% by weight, based on the total weight of the monomers M1, of at least one monomer M1.2;
   a.3) 0 to 10% by weight or 0.1 to 10% by weight, in particular in the range of 0 to 8% by weight or 0.2 to 8% by weight and especially in the range of 0 to 5% by weight or 0.5 to 5% by weight, based on the total weight of the monomers M1, of one or more monomers M1.3;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the monomers M2 are selected from the monomers of the formulae M2-1 and M2-2 and/or where the chain transfer compound C has at least 2 SH groups.

In a particular group 6.1 of embodiments, the polymer P of the aqueous polymer dispersion of the present invention is formed from polymerized units of a mixture of the monomers M and the chain transfer agent C, where the mixture comprises
a) 60 to 97% by weight, in particular 65 to 95% by weight and especially 65 to 92.5% by weight of at least one monoethylenically unsaturated monomer M1; comprising
   a.1) 85.0 to 99.9% by weight, in particular 90.0 to 99.8% by weight or 90.0 to 99.7% by weight and especially 90.0 to 99.5% by weight or 90.0 to 99.0% by weight, based on the total weight of monomers M1, of at least one monomer M1.1, in particular a combination of at least one monomer M1.1a and at least one monomer M1.1b, in particular a combination according to group 2 or subgroup 2a of embodiments;
   a.2) 0.1 to 10% by weight, in particular in the range of 0.2 to 7% by weight and especially 0.3 to 5% by weight, based on the total weight of the monomers M1, of at least one monomer M1.2;
   a.3) 0 to 10% by weight or 0.1 to 10% by weight, in particular in the range of 0 to 8% by weight or 0.2 to 8% by weight and especially in the range of 0 to 5% by weight or 0.5 to 5% by weight, based on the total weight of the monomers M1, of one or more monomers M1.3;
b) 2 to 25% by weight, in particular 3 to 22% by weight and especially 5 to 20% by weight of at least one multiethylenically unsaturated monomer M2;
c) 1 to 25% by weight, in particular 2 to 22% by weight and especially 2.5 to 20% by weight of at least one chain transfer compound C,
where the percentages given here amount to 100% by weight and are based on the total weight of monomers M+chain transfer compound C in the mixture and where the monomers M2 are selected from the monomers of the formulae M2-1 and M2-2 and/or where the chain transfer compound C is of the formula C-1.

The polymer P contained in the polymer particles of the aqueous polymer dispersion according to the present invention usually shows a glass transition. For the purpose of this invention, the glass transition temperature Tg does usually not exceed 120° C. and may be as low as −70° C., depending on the desired application. For use as binders in coating compositions, such as architectural coatings or decorative coatings including exterior and interior paints, the glass transition temperature Tg preferably does not exceed +50° C., in particular +40° C. or +35° C. and is frequently in the range of −30 to +50° C., in particular in the range of −25 to +40° C. and especially in the range of −20 to +35° C. For adhesive compositions the glass transition temperature Tg of the polymer P preferably does not exceed 10° C. and is frequently in the range of −70 to +10° C. For fiber bonding the glass transition temperature Tg of the polymer P is preferably at least +10° C. and is frequently in the range of +20 to +120° C. The polymer particles may have a single phase of the polymer P or it may form different phases, if the polymer particles contain different polymers P, which differ with regard to their monomer composition.

The glass transition temperature as referred to herein is the actual glass transition temperature, which can be determined experimentally by the differential scanning calorimetry (DSC) method according to ISO 11357-2:2013, preferably with sample preparation according to ISO 16805:2003.

The actual glass transition temperature depends on the monomer compositions forming the polymer P contained in the polymer particles of the aqueous polymer latex according to the present invention. The actual glass transition temperature can be estimated by calculating a theoretical glass transition temperature Tg^{t} from the monomer composition used in the emulsion polymerisation. The theoretical glass transition temperatures are usually calculated by the Fox equation:

$$1 / {Tg}^{t} = {x}_{a} / {Tg}_{a} + {x}_{b} / {Tg}_{b} + … {x}_{n} / {Tg}_{n} ,$$

In this equation, xₐ, x_{b}, . . . xₙ are the mass fractions of the monomers a, b, . . . n, and Tgₐ, Tg_{b}, . . . Tgₙ are the actual glass transition temperatures in Kelvin of the homopolymers synthesized from only one of the monomers a, b, . . . n at a time. The Fox equation is described by T. G. Fox in Bull. Am. Phys. Soc. 1956, 1, page 123 and as well as in Ullmann's Encyclopädie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

Preferably, the particles of the polymer P contained in the polymer latex have a Z-average particle diameter, as determined by QELS, in the range of 50 to 500 nm, in particular in the range of 50 to 300 nm. Here and in the following, the particle size and particle size distribution refers to values determined by dynamic light scattering according to the ISO 13321:1996 standard.

The particle size distribution of the copolymer particles contained in the polymer latex may be monomodal or almost monomodal, which means that the distribution function of the particle size has a single maximum and no particular shoulder. The particle size distribution of the copolymer particles contained in the polymer latex may also be polymodal or almost polymodal, which means that the distribution function of the particle size has at least two distinct maxima or at last one maximum and at least a pronounced shoulder.

If not stated otherwise, the size of the particles as well as the distribution of particle size is determined by quasielastic light scattering (QELS), also known as dynamic light scattering (DLS). The measurement method is described in the ISO 13321:1996 standard. The determination can be carried out using a High-Performance Particle Sizer (HPPS). For this purpose, a sample of the aqueous polymer latex will be diluted and the dilution will be analyzed. In the context of QELS, the aqueous dilution may have a polymer concentration in the range of 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a non-ionic emulsifier, e.g. an ethoxylated C16/C18 alkanol (degree of ethoxylation of 18), as a diluent. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173°; wavelength laser 633 nm (HeNe); refractive index of medium 1.332 (aqueous); viscosity 0.9546 mPa·s. The measurement gives an average value of the second order cumulant analysis (mean of fits), i.e. Z average. The “mean of fits” is an average, intensity-weighted hydrodynamic particle diameter in nm.

For the purpose of the invention, the aqueous polymer dispersion of the present invention generally has solids contents in the range of 10 to 75% by weight, preferably in the range of 20 to 65% by weight, in particular in the range of 30 to 60% by weight. The solids content describes the proportion of nonvolatile fractions and can be measured according to the standard method DIN EN ISO 3251: 2008-06. The solids content of a polymer dispersion may in particular be determined by means of a balance with infrared moisture analysis. In this determination, a quantity of polymer dispersion is introduced into the instrument, heated to 140° C. and subsequently held at that temperature. As soon as the average decrease in weight falls below 1 mg within 140 seconds, the measurement procedure is ended. Alternatively, the solids content of a polymer dispersion may in particular be determined by heating the polymer dispersion to 140° C. for 2 h and subsequently determining the weight loss. The ratio of weight after drying to original mass introduced gives the solids content of the polymer dispersion. The total solids content of the formulation is determined arithmetically from the amounts of the substances added and from their solids contents and concentrations.

For the purpose of the invention, the aqueous polymer dispersions of the present invention have a pH in the range of pH 1 to pH 12, in particular in the range of pH 2 to pH 11, as determined at 20° C. and 1 bar.

For the purpose of the present invention, the polymer dispersions of the present invention contain at least one surfactant which may be non-ionic or anionic or cationic with preference given to non-ionic and anionic surfactants and combinations thereof. In particular, the polymer dispersions of the present invention contain at least one anionic emulsifier, which has at least one anionic group selected from sulfonate groups, sulfate groups, phosphonate groups and phosphate groups.

Preferred anionic emulsifiers are in particular those which bear at least one sulfate or sulfonate group. Likewise, anionic emulsifiers which bear at least one phosphate or phosphonate group may be used, either as sole anionic emulsifiers or in combination with one or more anionic emulsifiers which bear at least one sulfate or sulfonate group.

Examples of preferred anionic emulsifiers which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of alkylethersulfates, i. e. of sulfuric monoesters of ethoxylated alkanols, especially of sulfuric monoesters of ethoxylated C₈-C₂₂-alkanols, preferably having an ethoxylation level (EO level) in the range from 2 to 40,
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₈-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The latter are common knowledge, for example from U.S. Pat. No. 4,269,749, and are commercially available, for example as Dowfax® 2A1 (Dow Chemical Company),
surfactants, which have a polymerizable ethylenically unsaturated double bond as described herein, e.g. the compounds of the formulae (I)-(IV), where X and Y, respectively, are SO₃⁻ or O—SO₃⁻.

Examples of anionic emulsifiers which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylatedco-propoxylated C₈-C₂₂-alkanols, preferably having an ethoxylation level (EO level) in the range from 1 to 20 and a propoxylation level of 1 to 20,
the salts, especially the alkali metal and ammonium salts, of alkylphosphonic acids, especially C₈-C₂₂-alkylphosphonic acids and
the salts, especially the alkali metal and ammonium salts, of alkylbenzenephosphonic acids, especially C₄-C₂₂-alkylbenzenephosphonic acids.
surfactants, which have a polymerizable ethylenically unsaturated double bond as described herein, e.g. the compounds of the formulae (I)-(IV), where X and Y, respectively, are HPO₃⁻, PO₃², O—HPO₃⁻ or O—PO₃².

Anionic emulsifiers may also comprise emulsifiers, which have a polymerizable double bond, e.g. the emulsifiers of the formulae (I) to (IV) and the salts thereof, in particular the alkalimetal salts or ammonium salts thereof:

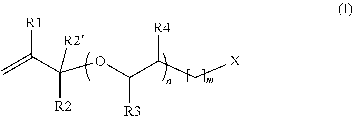

In formula (I), R¹ is H, C₁-C₂₀-alkyl, C₅-C₁₀-cycloalkyl, phenyl optionally substituted with C₁-C₂₀-alkyl, R² and R^{2′} are both H or together are 0, R³ and R⁴ are H or methyl, m is 0 or 1, n is an integer from 1-100 and X is SO₃⁻, O—SO₃⁻, O—HPO₃⁻ or O—PO₃²⁻.

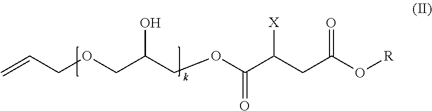

In formula (II), R is H, C₁-C₂₀-alkyl, C₅-C₁₀-cycloalkyl, phenyl optionally substituted with C₁-C₂₀-alkyl, k is 0 or 1 and X is SO₃⁻, O—SO₃⁻, O—HPO₃⁻ or O—PO₃²⁻.

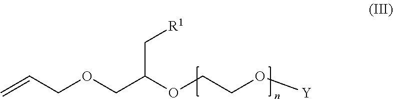

In formula (III), R¹ is H, C₁-C₂₀-alkyl, O—C₁-C₂₀-alkyl, C₅-C₁₀-cycloalkyl, O—C₅-C₁₀-cycloalkyl, O-phenyl optionally substituted with C₁-C₂₀-alkyl, n is an integer from 1-100 and Y is SO₃, HPO₃⁻ or PO₃²⁻.

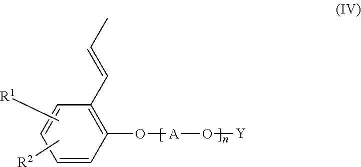

In formula (IV), R¹ is H, C₁-C₂₀-alkyl or 1-phenylethyl, R² is H, C₁-C₂₀-alkyl or 1-phenylethyl, A is C₂-C₄-alkanediyl, such as 1,2-ethanediyl, 1,2-propanediyl, 1,2-butanediyl or 1,4-butanediyl, n is an integer from 1-100 and Y is SO₃⁻, HPO₃⁻ or PO₃²⁻.

Particular embodiments of the copolymerizable emulsifiers of the formula (I) are referred to as sulfate esters or phosphate esters of polyethylene glycol monoacrylates. Particular embodiments of the copolymerizable emulsifiers of the formula (I) may likewise also be referred to as phosphonate esters of polyethylene glycol monoacrylates, or allyl ether sulfates. Commercially available co-polymerizable emulsifiers of the formula (I) are Maxemul® emulsifiers, Sipomer® PAM emulsifiers, Latemul® PD, and ADEKA Reasoap® PP-70. Particular embodiments of the copolymerizable emulsifiers of the formula (II) are also referred to as alkyl allyl sulfosuccinates. Commercially available copolymerizable emulsifiers of the formula (II) is Trem® LF40. Particular embodiments of the copolymerizable emulsifiers of the formula (Ill) are also referred to as branched unsaturated. Commercially available copolymerizable emulsifiers of the formula (III) are Adeka® Reasoap emulsifiers and Hitenol® KH. Particular embodiments of the copolymerizable emulsifiers of the formula (IV) are also referred to as polyoxyethylene alkylphenyl ether sulfate and polyoxyethylene mono- or distyrylphenyl ether sulfate. Commercially available copolymerizable emulsifiers of the formula (IV) are Hitenol® BC and Hitenol® AR emulsifiers.

Further suitable anionic emulsifiers can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

Preferably, the surfactant comprises at least one anionic emulsifier which bears at least one sulfate or sulfonate group. The at least one anionic emulsifier which bears at least one sulfate or sulfonate group, may be the sole type of anionic emulsifiers. However, mixtures of at least one anionic emulsifier which bears at least one sulfate or sulfonate group and at least one anionic emulsifier which bears at least one phosphate or phosphonate group may also be used. In such mixtures, the amount of the at least one anionic emulsifier which bears at least one sulfate or sulfonate group is preferably at least 50% by weight, based on the total weight of anionic surfactants used in the process of the present invention. In particular, the amount of anionic emulsifiers which bear at least one phosphate or phosphonate group does not exceed 20% by weight, based on the total weight of anionic surfactants used in the process of the present invention.

Preferred anionic surfactants are anionic emulsifiers which are selected from the following groups, including mixtures thereof:
the salts, especially the alkali metal and ammonium salts, of alkyl sulfates, especially of C₈-C₂₂-alkyl sulfates,
the salts, especially the alkali metal salts, of alkylether sulfates, i. e. of sulfuric monoesters of ethoxylated alkanols, especially of sulfuric monoesters of ethoxylated C₈-C₂₂-alkanols, preferably having an ethoxylation level (EO level) in the range from 2 to 40,
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.
polymerizable emulsifiers of the formula (III) and
   combinations thereof.

Particular preference is given to anionic emulsifiers which are selected from the following groups including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40.
   and combinations thereof.

In addition to the aforementioned anionic emulsifiers, the surfactant contained in the polymer latex of the film-forming polymer P may also comprise one or more nonionic surface-active substances which are especially selected from nonionic emulsifiers. Suitable nonionic emulsifiers are e.g. araliphatic or aliphatic nonionic emulsifiers, for example ethoxylated mono-, di- and trialkylphenols (EO level: 3 to 50, alkyl radical: C₄-C₁₀), ethoxylates of long-chain alcohols (EO level: 3 to 100, alkyl radical: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols, in particular to those, where the alkyl radical C₈-C₃₀ having a mean ethoxylation level of 5 to 100 and, among these, particular preference to those having a linear C₁₂-C₂₀ alkyl radical and a mean ethoxylation level of 10 to 50.

The surfactants contained in the polymer latex of the film-forming polymer P preferably comprise not more than 90% by weight of nonionic surfactants based on the total amount of surfactants contained in the polymer latex. Combinations of at least one anionic surfactant and at least non-ionic surfactant may also be used. In this case, the weight ratio of the total amount of anionic surfactant to the total amount of non-ionic surfactant is in the range of 99:1 to 10:90.

Preferably, the amount of emulsifier will be used in such an amount that the amount of anionic emulsifier is in the range from 0.2 to 5% by weight, especially in the range from 0.3 to 4.5% by weight, based on the polymer P.

Besides the polymer and the surfactant, the aqueous polymer latex of the film-forming polymer P may contain further ingredients conventionally present in aqueous polymer dispersions. These further ingredients are, for example, defoamers, biocides and the like. Further ingredients may also be acids, bases, buffers and decomposition products from the polymerization reaction or deodorizing compounds. The amount of the respective individual component will typically not exceed 1.5 wt %, based on the total weight of the polymer dispersion. The total amount of these stated components will typically not exceed 5 wt %, based on the total weight of the polymer dispersion.

It is preferred that at least part of the educts used to prepare the aqueous polymer dispersion is from biorenewable raw materials, including in particular the monomers, the chain transfer agents and the surfactants. Therefore, a particular embodiment of the invention relates to a polymer dispersion as defined herein, wherein at least a portion of the carbon atoms of the monomers M, the chain transfer agent and/or the surfactants are of biological origin, i.e. they are at least partly made of bio-carbon. For examples alcohols for producing acrylate esters or methacrylate esters preferably have a content of bio-carbon of at least 50 mol-%, based on the total amount of carbon atoms in the alcohols. Suitable alcohols include methanol, ethanol, isobutanol, isoamyl alcohol, 2-octanol, cyclopentanol and polyhydric alcohols of the (meth)acrylate type monomers M2. This content may be as high as 100 mol-%. Similarly, acrylic acid and/or methacrylic acid may be produced from renewable materials.

Here and throughout the specification, the term “bio-based compound” means that the respective compound is at least partly produced from molecules, which are obtained from a bio-renewable resource, such as biomass. Such molecules are characterized by a content of bio-carbon of at least 90 mol-%, preferably at least 95 mol-%, e.g. 100 mol-%, based on the total amount of carbon atoms.

The term “bio-carbon” indicates that the carbon is of biological origin and comes from a biomaterial/renewable resources. Here and in the following renewable sources and bio-renewable sources are used synonymously and refer to sources of biological origin other than fossil sources. The content in bio-carbon and the content in biomaterial are expressions that indicate the same value. A material of renewable origin or biomaterial is an organic material wherein the carbon comes from the CO₂ fixed recently (on a human scale) by photosynthesis from the atmosphere. A biomaterial (Carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of bio-carbon can be carried out in accordance with the standards ASTM D 6866-12, the method B (ASTM D 6866-06) and ASTM D 7026 (ASTM D 7026-04).

The method for producing an aqueous polymer dispersion can be carried out by analogy to known methods for producing aqueous emulsion polymerization, in particular a free radical aqueous emulsion polymerization, of the monomers M and the chain transfer compound where the amount of the chain transfer compound and the type and amount of monomers M is chosen as described herein. The term “free radical aqueous emulsion polymerization” means that the polymerization of the monomers M is initiated by radicals formed by the decay of a polymerization initiator, whereby free radicals are formed in the polymerization mixture. It is therefore also termed “radically initiated emulsion polymerization”. The procedure for radically initiated emulsion polymerizations of monomers in an aqueous medium has been extensively described and is therefore sufficiently familiar to the skilled person [cf. in this regard Emulsion Polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422; and Dispersionen synthetischer Hochpolymerer, F. Hölscher, Springer-Verlag, Berlin (1969)]. Typical procedures for aqueous emulsion polymerization of ethylenically unsaturated monomers are also described in the patent literature discussed in the introductory part of this patent application.

The radically initiated aqueous emulsion polymerization is typically carried out by emulsifying the ethylenically unsaturated monomers M and the chain transfer compound C in the aqueous medium which forms the aqueous phase, typically by use of surface active compounds, such as emulsifiers and/or protective colloids, and polymerizing this system using at least one initiator which decays by formation of radicals and thereby initiates the chain growth addition polymerization of the ethylenically unsaturated monomers M. The preparation of an aqueous polymer dispersion in accordance with the present invention may differ from this general procedure in the specific use of the aforementioned monomers M and the chain transfer compound C in the required amounts. It will be appreciated here that the process shall, for the purposes of the present specification, also encompass the seed, staged, one-shot, and gradient regimes which are familiar to the skilled person.

The free-radically initiated aqueous emulsion polymerization is triggered by means of a free-radical polymerization initiator (free-radical initiator). These may, in principle, be peroxides or azo compounds. Of course, redox initiator systems are also useful. Peroxides used may, in principle, be inorganic peroxides such as hydrogen peroxide or peroxodisulfates such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide and also dialkyl or diaryl peroxides such as di-tert-butyl or di-cumyl peroxide. Azo compounds used are essentially 2,2′-azobis(isobutyronitrile), 2,2′-azobis(2,4-dimethylvaleronitrile) and 2,2′-azobis(amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols such as dihydroxymaleic acid, benzoin and/or ascorbic acid, and reducing saccharides such as sorbose, glucose, fructose and/or dihydroxyacetone.

Preferred free-radical initiators are inorganic peroxides, especially peroxodisulfates.

In general, the amount of the free-radical initiator used, based on the total amount of monomers M, is 0.1 to 2 pphm, preferably 0.2 to 1 pphm, based on the total amount of monomers M.

The amount of free-radical initiator required for the emulsion polymerization of monomers M can be initially charged in the polymerization vessel completely. However, it is also possible to charge none of or merely a portion of the free-radical initiator, for example not more than 30% by weight, especially not more than 20% by weight, based on the total amount of the free-radical initiator and then to add any remaining amount of free-radical initiator to the free-radical polymerization reaction under polymerization conditions. Preferably, at least 70%, in particular at least 80%, especially at least 90% or the total amount of the polymerization initiator are fed to the free-radical polymerization reaction under polymerization conditions. Feeding of the monomers M may be done according to the consumption, batchwise in one or more portions or continuously with constant or varying flow rates during the free-radical emulsion polymerization of the monomers M and the chain transfer agent.

Generally, the term “polymerization conditions” is understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected, such that a sufficient amount of initiating radicals is always present to initiate or to maintain the polymerization reaction.

Preferably, the radical emulsion polymerization of the monomers M and the chain transfer compound C is performed by a so-called feed process (also termed monomer feed method), which means that at least 80%, in particular at least 90% or the total amount of the monomers M and the chain transfer compound C to be polymerized are metered to the polymerization reaction under polymerization conditions during a metering period P. Preferably the monomers M and the chain transfer compound C are metered to the polymerization reaction as a mixture, in particular as a pre-emulsion. However, it is also possible to meter the monomers M and the chain transfer compound C via separate feeds. It is possible that the ratio of monomers M and the chain transfer compound C may vary during the feed period P to achieve a non-uniform distribution of the chain transfer agent in the polymer formed. It is possible that the ratio of monomers M1 and M2 may vary during the feed period P to achieve a non-uniform distribution of the monomers M2 in the polymer formed.

Addition may be done in portions and preferably continuously with constant or varying feed rate. The duration of the period P may depend on the production equipment and may vary from e.g. 20 minutes to 12 h. Frequently, the duration of the period P will be in the range from 0.5 h to 8 h, especially from 1 h to 6 h. In a multistep emulsion polymerization step, the total duration of all steps is typically in the above ranges. The duration of the individual steps is typically shorter. Preferably, at least 70%, in particular at least 80%, especially at least 90% or the total amount of the polymerization initiator is introduced into emulsion polymerization in parallel to the addition of the monomers.

The aqueous radical emulsion polymerization is usually performed in the presence of one or more suitable surfactants as described herein, which preferably comprise at least one anionic emulsifier as described above or a combination thereof with at least one non-ionic emulsifier as described above. These surfactants typically comprise emulsifiers and provide micelles, in which the polymerization occurs, and which serve to stabilize the monomer droplets during aqueous emulsion polymerization and also growing polymer particles. The surfactants used in the emulsion polymerization are usually not separated from the polymer dispersion, but remain in the aqueous polymer dispersion obtainable by the emulsion polymerization of the monomers M and the chain transfer compound C.

Preferably, the major portion, i.e. at least 80% of the surfactant used, is added to the emulsion polymerization in parallel to the addition of the monomers and the chain transfer compound C. In particular, the monomers are added as an aqueous emulsion to the polymerization reaction which contains at least 80% of the surfactant used in the emulsion polymerization.

It has been found advantageous to perform the free-radical emulsion polymerization of the monomers M and the chain transfer compound C in the presence of a seed latex. A seed latex is a polymer latex which is present in the aqueous polymerization medium before the polymerization of monomers M and the chain transfer compound C is started. The seed latex may help to better adjust the particle size or the final polymer latex obtained in the free-radical emulsion polymerization of the invention.

Principally, every polymer latex may serve as a seed latex. For the purpose of the invention, preference is given to seed latices, where the particle size of the polymer particles is comparatively small. In particular, the Z average particle diameter of the polymer particles of the seed latex, as determined by dynamic light scattering (DLS) at 20° C. (see below), is preferably in the range from 10 to 80 nm, in particular from 10 to 50 nm. Preferably, the polymer particles of the seed latex is made of ethylenically unsaturated monomers which comprise at least 95% by weight, based on the total weight of the monomers forming the seed latex, of one or more monomers selected from the group consisting of C₂-C₁₀-alkyl esters of acrylic acid, in particular ethyl acrylate, n-butyl acrylate, n-hexyl acrylate, n-octyl acrylate, 2-octyl acrylate, 2-ethyl-hexylacrylate, C₁-C₄-alkyl methacrylates such as methyl methacrylate, monoethylenically unsaturated nitriles, such as acrylonitrile and vinylaromatic monomers as defined above such as styrene and mixtures thereof. In particular, the polymer particles of the seed latex is made of ethylenically unsaturated monomers which comprise at least 95% by weight, based on the total weight of the monomers forming the seed latex, of one or more monomers selected from the group consisting of C₁-C₄-alkyl methacrylates such as methyl methacrylate, monoethylenically unsaturated nitriles, such as acrylonitrile and vinylaromatic monomers as defined above such as styrene and mixtures thereof.

For this, at least a partial amount or the total amount of the seed latex is usually charged into the polymerization vessel before the polymerization of the monomers M and the chain transfer compound C is started. In particular, the seed latex is charged into the polymerization vessel followed by establishing the polymerization conditions, e.g. by heating the mixture to polymerization temperature. It may be beneficial to charge at least a portion of the free-radical initiator into the polymerization vessel before the addition of the monomers M is started. However, it is also possible to add the monomers M, the chain transfer compound C and the free-radical polymerization initiator in parallel to the polymerization vessel.

The amount of seed latex, calculated as solids, may frequently be in the range of 0.01 to 5% by weight, in particular in the range of 0.05 to 3% by weight, especially in the range of 0.1 to 2% by weight, based on the total weight of the monomers in the monomer composition M to be polymerized.

The free-radical aqueous emulsion polymerization of the invention can be carried out at temperatures in the range from 0 to 170° C. Temperatures employed are generally in the range from 50 to 120° C., frequently 60 to 120° C. and often 70 to 110° C. The free-radical aqueous emulsion polymerization of the invention can be conducted at a pressure of less than, equal to or greater than 1 atm (atmospheric pressure), and so the polymerization temperature may exceed 100° C. and may be up to 170° C. Polymerization of the monomers is normally performed at ambient pressure, but it may also be performed under elevated pressure. In this case, the pressure may assume values of 1.2, 1.5, 2, 5, 10, 15 bar (absolute) or even higher values. If emulsion polymerizations are conducted under reduced pressure, pressures of 950 mbar, frequently of 900 mbar and often 850 mbar (absolute) are established. Advantageously, the free-radical aqueous emulsion polymerization of the invention is conducted at ambient pressure (about 1 atm) with exclusion of oxygen, for example under an inert gas atmosphere, for example under nitrogen or argon.

The process for producing the polymer dispersion of the present invention may be a single stage polymerization or a multistage emulsion polymerization. In a single stage polymerization, the overall composition of the monomers M and the chain transfer compound C, which are fed to the polymerization reaction under polymerization conditions, remains the same or almost the same, while in a multistage emulsion polymerization the overall composition of the monomers M and or the ratio of monomers M and chain transfer compound C, which are fed to the polymerization reaction under polymerization conditions, is altered at least once, in particular such that the theoretical glass transition temperature of the resulting polymer formed in one stage differs from the theoretical glass transition temperature of the resulting polymer formed in another stage by at least 10° C., in particular by at least 20° C. or at least 40° C.

In a particular group of embodiments, the process of the invention is performed as a 2-stage emulsion polymerization, i.e. the composition of the monomers, which are fed to the polymerization reaction under polymerization conditions, is amended once, or as a 3- or 4-stage emulsion polymerization, i.e. the composition of the monomers, which are fed to the polymerization reaction under polymerization conditions, is amended twice or trice.

It is frequently advantageous, when the aqueous polymer dispersion obtained on completion of polymerization of the monomers M compound M is subjected to an after-treatment to reduce the residual monomer content. This after-treatment is effected either chemically, for example by completing the polymerization reaction using a more effective free-radical initiator system (known as chemical deodorization), and/or physically, for example by stripping the aqueous polymer dispersion with steam or inert gas. Corresponding chemical and physical methods are familiar to those skilled in the art—see, for example, EP-A 771328, DE-A 19624299, DE-A 19621027, DE-A 19741184, DE-A 19741187, DE-A 19805122, DE-A 19828183, DE-A 19839199, DE-A 19840586 and DE-A 19847115. The combination of chemical and physical after-treatment has the advantage that it removes not only the unconverted ethylenically unsaturated monomers, but also other disruptive volatile organic constituents (VOCs) from the aqueous polymer dispersion.

As the polymer contained in the aqueous polymer dispersion of the present invention may contain acidic groups from the monomers M1.2 and optionally from the polymerization initiator, the aqueous polymer dispersion has typically an acidic pH, which is frequently below pH 4, e.g. in the range of pH 1 to <pH 4.0. Thus, it may be necessary to adjust the pH of the polymer dispersion to the desired value by addition of an acid or a base or a buffer.

The polymer dispersion of the present invention can be tailored to the desired application by using proper monomers M1. Suitable uses include the use of the polymer dispersion as a binder, in particular as a binder in coating compositions, such as architectural coatings, decorative coatings, industrial coatings, coatings for roof tiles, coatings for fibre cement boards, for flatroof coatings, for paper coating, for sizing agents, for printing inks, for overprint varnishes and primers. The polymer dispersions of the present invention may be used as a binder in waterproofing membranes, as a binder in sealants, as a binder for fibre bonding or paper. The polymer dispersions of the present invention may be also used as an adhesive component in adhesives, such as pressure sensitive adhesives, flooring adhesives and tile adhesives. The polymer dispersions of the present invention may be also used as organic opacifiers and as rubbers and impact modifiers for thermoplastics.

For some applications, it might be suitable to formulate the polymer dispersion of the invention with a post-curing agent. Ideally, such a post-curing agent, also termed as post-crosslinking agent, will result in a crosslinking reaction during and/or after film formation by forming coordinative or covalent bonds with reactive sites on the surface of the polymer particles of the polymer dispersion.

Crosslinking agents, which are suitable for providing post crosslinking, are for example compounds having at least two functional groups selected from oxazoline, amino, aldehyde, aminoxy, carbodiimide, aziridinyl, epoxy and hydrazide groups, derivatives or compounds bearing acetoacetyl groups. These crosslinkers react with reactive sites of the polymers of the polymer dispersion which bear complementary functional groups in the polymer, which are capable of forming a covalent bond with the crosslinker. Suitable systems are known to skilled persons.

Other suitable agents of achieving post-curing include
epoxysilanes to crosslink carboxy groups in the polymer;
dialdehydes such as glyoxal to crosslink urea groups or acetoacetoxy groups, such as those derived from the monomers M5b and M5c, respectively, as defined herein, in particular ureido (meth)acrylate or acetoacetoxyethyl (meth)acrylate;
di- and/or polyamines to crosslink keto groups or epoxy groups such as those derived from the monomers M5c or M6b as defined herein; and
UV initiators such as benzophenones, including benzophenone, 4-methoxybenzophenone, 4-methylbenzophenone, 2,4,6-trimethylbenzophenone, acetophenones, such as 2-hydroxy-2,2-dimethylacetophenone, 2-phenyl-2,2-dimethylacetophenone, cycloalkylphenyl ketones, such as 1-benzoylcyclohexan-1-ol (=1-hydroxycyclhexylphenyl ketone) and benzoins and mixtures thereof, in particular liquid mixtures such as mixtures of 4-methylbenzophenone and benzophenone, mixtures of 2,4,6-trimethylbenzophenone and benzophenone and mixtures of 1-hydroxycyclhexylphenyl ketone and benzophenone,
Water soluble salts of polyvalent cations, such as Al³⁺, Zn²⁺, Ca²⁺, Zr⁴⁺ e. g. the sulfates, chlorides or hydroxides or respective complex salts e.g. with ammonia, acetyl acetone or polycarboxylates.

Suitable systems are e.g. described in EP 355028, EP 441221, EP 0789724, U.S. Pat. Nos. 5,516,453 and 5,498,659 and/or commercially available, e.g. in case of UV initiators from Omnirad and IGM Resins (e.g. Esacure TZM, Esacure TZT, Omnirad 4MBZ).

If used as a binder, the aqueous polymer dispersion of the present invention may be used as the sole organic binder polymer but it may also be used in combination with other organic binder polymer dispersions.

For example, the aqueous polymer dispersion of the present invention may be used as a binder in waterborne coating compositions. In this regard, it may be formulated as a clear coat, as a glace formulation or a as a paint formulation. In the latter case, the waterborne coating compositions contain, in addition to the polymer latex, at least one organic or inorganic pigment, which imparts a white shade or a color to the coating obtained when using the waterborne coating composition for coating substrates.

Pigments for the purposes of the present invention are virtually insoluble, finely dispersed, organic or preferably inorganic colorants as per the definition in German standard specification DIN 55944:2003-11. Such coating compositions may further contain conventional formulation aids, such as rheology modifiers, dispersants, biocides, plasticizers and filming aids. Suitable formulation auxiliaries and components are e.g. described by J. Bieleman in “Additives for Coatings”, Whiley-VCH, Weinheim 2000; by T. C. Patton in “Paint Flow and Pigment Dispersions”, 2nd Edition, John Whiley & Sons 1978; and by M. Schwartz and R. Baumstark in “Water based Acrylates for Decorative Coatings”, Curt R. Vincentz Verlag, Hanover 2001.

The invention is hereinafter described by way of examples.

### EXAMPLES

### Abbreviations

AA: acrylic acid
AMA allyl methacrylate
d day
DLS dynamic light scattering
DSC differential scanning calorimetry
BDA2: 1,4-butandiol diacrylate
EGDMA: ethylene glycol dimethacrylate
EGMP: ethylene glycol bis(3-mercaptopropionate)
EHTG: 2-ethylhexyl thioglycolate
h hour
MFFT: minimum film forming temperature
MMA: methyl methacrylate
nBA: n-butyl acrylate
NGDA: nonaethylene glycol diacrylate (Sartomer® SR 344, Arkema)
RT room temperature
TGDMA: tetraethylene glycol dimethacrylate (Bisomer® PEG 200 DMA, GEO_Specialty Chemicals)
TMPMP: trimethylolpropane tris(3-mercaptopropionate)
TriMA: trimethylolpropane-trimethacrylate
TMPTA: trimethylolpropane triacrylate

### Materials

Seed latex 1: all acrylic (100 pphm MMA), medium particle size: 30 nm, solid content: 30%
Emulsifier 1: sodium lauryl sulphate (15% aqueous solution, Disponil® SDS 15; BASF SE)
Seed latex 2: styrene acrylic (100 pphm styrene), medium particle size: 23 nm, solid content: 30%
Dispersant: 35% by weight aqueous solution of the sodium salt of a polyacrylic acid (Dispex AA 4145, BASF SE)
Defoamer: Polymer emulsion containing silicone (Foamstar ED 2523)
Thickener: Methyl hydroxyethyl cellulose (Tylose MH 30000 YP4, Shin-Etsu Chemical).
Polyphosphate: Sodiumhexametaphosphate (Calgon N of ICL)
TiO₂—Pigment: Rutile type TiO₂ pigment (Kronos 2044, Kronos B.V.)
Filler 1: Kaolin (China Claim B)
Filler 2: Calcium carbonate with a particle size (d50) of 2 μm (Omyacarb 2 GU, Omya GmbH)
Filler 3: Calcium carbonate with a particle size (d50) of 6.0 μm (Omyacarb 5 GU, Omya GmbH)

### Analytics

i) Solids contents of the polymer dispersions were measured according to the standard method DIN EN ISO 3251: 2008-06.
ii) pH values of the polymer dispersions were measured according to the standard method DIN EN 1262:2004-01.
iii) The glass transition temperature (Tg) was determined by the DSC method (20 K/min, midpoint measurement, DIN 53765:1994-03) by means of a DSC instrument (Q 2000 series from TA instruments).
iv) Particle Size Distribution of Polymer Dispersion by DLS
   The particle diameter of the polymer dispersion was determined by dynamic light scattering (DLS) of an aqueous polymer dispersion diluted with deionized water to 0.001 to 0.5% by weight at 22° C. by means of a HPPS from Malvern Instruments, England. What is reported is the cumulant Z average diameter calculated from the measured autocorrelation function (ISO Standard 13321).
v) Solubility of the latex particles
   Solubility of the latex particles was determined by adding one droplet of dispersion into 10 g of aqueous KOH (10% wt). The diluted dispersion was left for the appointed time and evaluated afterwards in a grading system.
   5: no difference observed
   4: slightly less turbid dispersion
   3: less turbid dispersion
   2: least turbid dispersion
   1: optically clear solution, scattering centers observed with a laser pointer
   0: optically clear solution, no scattering centers observed with a laser pointer
vi) Minimum film forming temperature (MFFT)
   The minimum film forming temperature of the polymer latex was determined in a film-forming bench with channels and a hood according to DIN 53787.

### Calculation of the Relative Amount of the Groups CFG of the Prepared Polymers

As described herein above, for a polymer according to the invention, the relative amount A_{CFG} of the groups CFG in mol/kg can be calculated from the amounts of monomers M2′ and from the amounts of the multifunctional chain transfer agents Cm′ by applying formula (A). Monomers M2′ are characterized by having n, i.e. one or more, cleavable functional groups CFG that are located between at least two ethylenically unsaturated double bonds of the monomer M2′, while transfer agents Cm′ are characterized by having at least 2 chain transfer groups CTG which are connected by a spacer group comprising k, i.e. one or more, functional groups CFG, as defined in more detail herein above. The following table A list the monomers M2′ and chain transfer agents Cm′ that were used in the following preparation examples. Table A also lists the molecular weights of these compounds as well as their number of groups CFG, i.e. the integers n and k. These values are required for calculating the relative amount A_{CFG} using formula (A).

TABLE A

| | M [g/mol] | n or k |
|---|---|---|
| Monomers M2′ | | |
| AMA | 126 | 1 |
| BDA2 | 198 | 2 |
| EGDMA | 198 | 2 |
| TGDMA | 346 | 2 |
| NGDA | 618 | 2 |
| TMPTA | 296 | 3 |
| TriMA | 338 | 3 |
| Transfer Agents Cm′ | | |
| EGMP | 238 | 2 |
| TMPMP | 399 | 3 |

### Preparation Examples

### Comparative Example 1

A polymerization vessel equipped with metering units and closed-loop temperature control was initially charged at 20 to 25° C. under a nitrogen atmosphere with the Precharge 1 and then heated to 85° C. while stirring. On attainment of this temperature, 2.06 g of Feed 2 were added and the mixture was stirred at 85° C. for further 5 minutes. Then, while maintaining the temperature, simultaneously Feed 1 and the remainder of Feed 2 were started. Feed 1 was metered at constant feed rate into the reaction vessel within 120 minutes and Feed 2 was metered at constant feed rate into the reaction vessel within 150 minutes, while stirring was continued and the temperature of 80° C. was maintained. After having metered Feed 2 completely into the reaction vessel the stirring at 85° C. was continued for 30 minutes.

### Precharge 1:

| | | |
|---|---|---|
| 445.60 | g | deionized water |
| 13.51 | g | Seed latex 1 |

### Feed 1 (an Emulsion Comprising):

| | | |
|---|---|---|
| 122.40 | g | deionized water |
| 26.67 | g | Emulsifier 1 |
| 12.00 | g | acrylic acid |
| 226.00 | g | n-butyl acrylate |
| 162.00 | g | methyl methacrylate |

### Feed 2:

| | |
|---|---|
| 17.14 g | sodium peroxodisulfate, solution in water (7 wt %) |

### Addition 1:

| | |
|---|---|
| 9.41 g | sodium hydroxide, solution in water (5 wt %) |

The obtained polymer latex was cooled to ambient temperature and Addition 1 was stirred in at room temperature. The dispersion was filtered through a 125 μm filter to remove coagulum. Thereby, around 1000 g of an aqueous polymer latex was obtained. The solid content of the polymer latex was 39.8%, the proportion of coagulum amounted to 0.0% by weight and the pH value of the polymer latex was found to be 6.2. Upon dilution with deionized water, the resulting aqueous polymer had a volume median particle diameter of 128 nm according to HDC. The application properties of the polymer latex are shown in table 1b.

### Comparative Example 2

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 200.00 | g | n-butyl acrylate |
| 148.00 | g | methyl methacrylate |
| 40.00 | g | 1,4-butandioldiacrylate |

This process yielded around 1000 g of an aqueous polymer latex. The physiochemical data of the obtained polymer latex are shown in table 1a, the application properties are shown in table 1b.

### Comparative Example 3

The preparation was carried out by analogy with that of Comparative Example 1, except that the following emulsion was used as Feed 1 and seed latex 2 was employed instead of seed latex 1:

### Feed 1 (an Emulsion Comprising):

| | | |
|---|---|---|
| 138.40 | g | deionized water |
| 26.67 | g | Emulsifier 1 |
| 12.00 | g | acrylic acid |
| 226.00 | g | n-butyl acrylate |
| 162.00 | g | methyl methacrylate |
| 40.00 | g | 2-ethylhexyl thioglycolate |

This process yielded around 1000 g of an aqueous polymer latex. The physiochemical data of the obtained polymer latex are shown in table 1a, the application properties are shown in table 1b.

### Comparative Example 4

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 226.00 | g | n-butyl acrylate |
| 162.00 | g | methyl methacrylate |
| 20.00 | g | 2-ethylhexyl thioglycolate |

This process yielded around 1000 g of an aqueous polymer latex. The physiochemical data of the obtained polymer latex are shown in table 1a, the application properties are shown in table 1b.

### Example 1

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 200.00 | g | n-butyl acrylate |
| 148.00 | g | methyl methacrylate |
| 40.00 | g | 1,4-butandioldiacrylate |
| 20.00 | g | 2-ethylhexyl thioglycolate |

This process yielded around 1000 g of an aqueous polymer latex. The physiochemical data of the obtained polymer latex are shown in table 1a, the application properties are shown in table 1b.

### Example 2

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 200.00 | g | n-butyl acrylate |
| 148.00 | g | methyl methacrylate |
| 40.00 | g | 1,4-butandioldiacrylate |
| 20.00 | g | ethylene glycol bis(3-mercaptopropionate) |

This process yielded around 1077 g of an aqueous polymer latex. The physiochemical data of the obtained polymer latex are shown in table 1a, the application properties are shown in table 1b.

### Example 3

The preparation was carried out by analogy with that of Example 1, except that instead of 40 g of 1,4-butandioldiacrylate, the same amount of ethylene glycol dimethacrylate was used.

This process yielded around 1000 g of an aqueous polymer latex. The physiochemical data of the obtained polymer latex are shown in table 1a, the application properties are shown in table 1b.

### Example 4

The preparation was carried out by analogy with that of Comparative Example 1, except the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 188.00 | g | n-butyl acrylate |
| 140.00 | g | methyl methacrylate |
| 60.00 | g | 1,4-butandioldiacrylate |
| 40.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

### Example 5

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 194.00 | g | n-butyl acrylate |
| 144.00 | g | methyl methacrylate |
| 50.00 | g | 1,4-butandioldiacrylate |
| 40.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

### Example 6

The preparation was carried out by analogy with that of Comparative Example 1, except that the following amounts of the monomers n-butyl acrylate and methyl methacrylate were used:

| | |
|---|---|
| 216.00 g | n-butyl acrylate |
| 132.00 g | methyl methacrylate |

This process yielded around 1000 g of an aqueous polymer latex. The physiochemical data of the obtained polymer latex are shown in table 1a, the application properties are shown in table 1b.

### Example 7

The preparation was carried out by analogy with that of Example 1, except that the following amounts of the monomers n-butyl acrylate and methyl methacrylate were used:

| | | |
|---|---|---|
| 276.00 | g | n-butyl acrylate |
| 72.00 | g | methyl methacrylate |

This process yielded around 1000 g of an aqueous polymer latex. The physiochemical data of the obtained polymer latex are shown in table 1a, the application properties are shown in table 1b.

### Example 8

The preparation was carried out by analogy with that of Comparative Example 1, except that the following amounts of the monomers n-butyl acrylate and methyl methacrylate were used:

| | |
|---|---|
| 184.00 g | n-butyl acrylate |
| 164.00 g | methyl methacrylate |

This process yielded around 1000 g of an aqueous polymer latex. The physiochemical data of the obtained polymer latex are shown in table 1a, the application properties are shown in table 1b.

### Example 9

The preparation was carried out by analogy with that of Comparative Example 1, except that the following amounts of the monomers n-butyl acrylate and methyl methacrylate were used:

| | |
|---|---|
| 116.00 g | n-butyl acrylate |
| 232.00 g | methyl methacrylate |

This process yielded around 1000 g of an aqueous polymer latex. The physiochemical data of the obtained polymer latex are shown in table 1a, the application properties are shown in table 1b.

### Example 10

The preparation was carried out by analogy with that of Comparative Example 1, except that instead of 40 g of 1,4-butandioldiacrylate, the same amount of poly(ethylene glycol) diacrylate (Mₙ=575 g/mol) was used.

This process yielded around 1000 g of an aqueous polymer latex. The physiochemical data of the obtained polymer latex are shown in table 1a, the application properties are shown in table 1b.

### Example 11

The preparation was carried out by analogy with that of Comparative Example 1, except that instead of 40 g of 1,4-butandioldiacrylate, the same amount of poly(ethylene glycol) diacrylate (Mₙ=400 g/mol) was used.

This process yielded around 1000 g of an aqueous polymer latex. The physiochemical data of the obtained polymer latex are shown in table 1a, the application properties are shown in table 1b.

### Example 12

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 202.40 | g | n-butyl acrylate |
| 150.00 | g | methyl methacrylate |
| 35.60 | g | pentaerythritol tetraacrylate |
| 20.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

### Example 13

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 195.40 | g | n-butyl acrylate |
| 144.60 | g | methyl methacrylate |
| 40.00 | g | 1,4-butandioldiacrylate |
| 8.00 | g | sodium 4-styrenesulfonate |
| 20.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

### Example 14

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 195.40 | g | n-butyl acrylate |
| 144.60 | g | methyl methacrylate |
| 40.00 | g | 1,4-butandioldiacrylate |
| 8.00 | g | 2-acrylamido-2-methylpropane sulfonic acid |
| 20.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

### Example 15

The preparation was carried out by analogy with that of Comparative Example 1, except that the following emulsion was used as Feed 1:

### Feed 1 (an Emulsion Comprising):

| | | |
|---|---|---|
| 122.40 | g | deionized water |
| 26.67 | g | Emulsifier 1 |
| 12.00 | g | acrylic acid |
| 183.90 | g | n-butyl acrylate |
| 136.10 | g | methyl methacrylate |
| 60.00 | g | 1,4-butandioldiacrylate |
| 8.00 | g | 2-acrylamido-2-methylpropane sulfonic acid |
| 40.00 | g | ethylene glycol bis(3-mercaptopropionate) |

This process yielded around 1000 g of an aqueous polymer latex. The physiochemical data of the obtained polymer latex are shown in table 1a, the application properties are shown in table 1b.

TABLE 1a
Properties of the prepared latexes

| | | | Tg | solid | | particle |
|---|---|---|---|---|---|---|
| | CFG | MFFT | (DSC) | content | | size |
| Example | [mol/kg] | [° C.] | [° C.] | [%] | pH | (DLS) [nm] |
| C1 | 0.00 | ≤0 | +8.6 | 39.8 | 6.2 | 128 |
| C2 | 1.01 | 9 | n.d. | 39.2 | 6.6 | 131 |
| C3 | 0.00 | ≤0 | +2.3 | 39.2 | 5.8 | 127 |
| C4 | 0.00 | n.d. | n.d. | 38.7 | 6.0 | 128 |
| 1 | 0.96 | ≤0 | n.d. | 39.1 | 6.5 | 133 |
| 2 | 1.36 | ≤0 | +0.8 | 38.9 | 6.3 | 139 |
| 3 | 1.36 | n.d. | n.d. | 38.9 | 6.9 | 136 |
| 4 | 2.14 | n.d. | n.d. | 39.0 | 6.9 | 144 |
| 5 | 1.91 | n.d. | n.d. | 38.7 | 6.9 | 155 |
| 6 | 1.36 | n.d. | −7 | 39.0 | 6.8 | 147 |
| 7 | 1.36 | n.d. | −26 | 38.7 | 6.5 | 147 |
| 8 | 1.36 | n.d. | +14 | 38.6 | 6.9 | 146 |
| 9 | 1.36 | n.d. | +33 | 39.3 | 7.2 | 147 |
| 10 | 1.36 | n.d. | n.d. | 38.8 | 6.0 | 239 |
| 11 | 1.36 | n.d. | n.d. | 38.5 | 6.2 | 186 |
| 12 | 1.26 | n.d. | n.d. | 38.4 | 6.7 | 146 |
| 13 | 1.55 | n.d. | n.d. | 36.3 | 7.0 | 157 |
| 14 | 1.55 | n.d. | n.d. | 39.1 | 6.7 | 157 |
| 15 | 2.33 | n.d. | n.d. | 38.8 | 6.6 | 159 |

TABLE 1b
Application properties of the prepared latexes

| | Solubility in KOH | Solubility in KOH | |
|---|---|---|---|
| Example | (4 h @50° C.) | (4 h @50° C.) | Tack rating |
| C1 | 5 | 5 | 0 |
| C2 | 5 | 5 | 0 |
| C3 | 5 | 5 | 1 |
| C4 | 4 | 3 | 3 |
| 1 | 5 | 3 | 0 |
| 2 | 4 | 1 | 0 |
| 3 | 4 | 2 | 0 |
| 4 | 1 | 1 | 0 |
| 5 | 1 | 1 | 3 |
| 6 | 4 | 1 | 3 |
| 7 | 4 | 1 | 3 |
| 8 | 5 | 3 | 0 |
| 9 | 5 | 4 | 0 |
| 10 | 3 | 1 | 3 |
| 11 | 2 | 1 | 3 |
| 12 | 2 | 0 | 0 |
| 13 | 3 | 3 | 0 |
| 14 | 3 | 3 | 0 |
| 15 | 1 | 1 | 3 |

### Example 16

A polymerization vessel equipped with metering units and closed-loop temperature control was initially charged at 20 to 25° C. under a nitrogen atmosphere with the Precharge 1 and then heated to 85° C. while stirring. On attainment of this temperature, 4.11 g of Feed 2 were added, and the mixture was stirred at 85° C. for further 5 minutes. Then, while maintaining the temperature, simultaneously Feed 1 and the remainder of Feed 2 were started. Feed 1 was metered at constant feed rate into the reaction vessel within 120 minutes and Feed 2 was metered at constant feed rate into the reaction vessel within 150 minutes, while stirring was continued and the temperature of 80° C. was maintained. After having metered Feed 2 completely into the reaction vessel the stirring at 85° C. was continued for 30 minutes.

### Precharge 1:

| | | |
|---|---|---|
| 891.20 | g | deionized water |
| 24.97 | g | Seed latex 2 |

### Feed 1 (an Emulsion Comprising):

| | |
|---|---|
| 405.57 g | deionized water |
| 53.33 g | Emulsifier 1 |
| 24.00 g (3.00 pphm) | acrylic acid |
| 315.84 g (39.48 pphm) | n-butyl acrylate |
| 300.16 g (37.52 pphm) | methyl methacrylate |
| 120.00 g (15.00 pphm) | 1,4-butandiol diacrylate |
| 40.00 g (5.00 pphm) | TGDMA (tetraethylene glycol dimethacrylate) |
| 41.24 g (5.00 pphm) | trimethylolpropane tris(3-mercaptopropionate) |
| 120.00 g (15.00 pphm) | ethylene glycol bis(3-mercaptopropionate) |

### Feed 2:

| | |
|---|---|
| 30.17 g | sodium peroxodisulfate, solution in water (7 wt %) |

### Addition 1:

| | |
|---|---|
| 64.00 g | sodium hydroxide, solution in water (5 wt %) |

The obtained polymer latex was cooled to ambient temperature and Addition 1 was stirred in at room temperature. The dispersion was filtered through a 125 μm filter to remove coagulum. Thereby, around 2500 g of an aqueous polymer latex was obtained. The solid content of the polymer latex was 39.2%, the proportion of coagulum amounted to 7.5 g·kg⁻¹ and the pH value of the polymer latex was found to be 5.4. Upon dilution with deionized water, the resulting aqueous polymer had a particle size of 159 nm according to DLS. The application properties of the latex are summarized in tables 3a, 3b and 3c.

### Examples 17 to 25

The preparations of the polymer latexes of Examples 17 to 25 were carried out by analogy to Example 16, with the exception that as ethylenically unsaturated monomers and chain transfer compounds those specified in table 2 are used in amounts also listed in table 2. The properties of the obtained polymer latexes as well as their application properties are summarized in tables 3a, 3b and 3c.

TABLE 2
Monomers and chain transfer compounds used for preparing the polymer latexes of Examples 16 to 25

| | EGMP* | EHTG* | TMPMP* | TriMA* | TMPTA* | NGDA* | EGDMA* | nBA* | MMA* | TGDMA* | BDA2* | AA* |
|---|---|---|---|---|---|---|---|---|---|---|---|---|
| Ex. | [pphm] | [pphm] | [pphm] | [pphm] | [pphm] | [pphm] | [pphm] | [pphm] | [pphm] | [pphm] | [pphm] | [pphm] |
| 16 | 15.00 | 0.00 | 5.00 | 0.00 | 0.00 | 0.00 | 0.00 | 39.48 | 37.52 | 5.00 | 15.00 | 3.00 |
| 17 | 0.00 | 5.00 | 15.00 | 0.00 | 0.00 | 0.00 | 0.00 | 42.05 | 39.95 | 15.00 | 0.00 | 3.00 |
| 18 | 5.00 | 0.00 | 0.00 | 15.00 | 5.00 | 0.00 | 0.00 | 39.48 | 37.52 | 0.00 | 0.00 | 3.00 |
| 19 | 5.00 | 0.00 | 15.00 | 0.00 | 0.00 | 0.00 | 15.00 | 47.75 | 34.25 | 0.00 | 0.00 | 3.00 |
| 20 | 5.00 | 0.00 | 15.00 | 15.00 | 0.00 | 0.00 | 0.00 | 42.56 | 40.44 | 0.00 | 0.00 | 2.00 |
| 21 | 0.00 | 5.00 | 0.00 | 0.00 | 0.00 | 0.00 | 0.00 | 39.48 | 37.52 | 5.00 | 15.00 | 3.00 |
| 22 | 0.00 | 5.00 | 15.00 | 0.00 | 15.00 | 0.00 | 0.00 | 45.42 | 32.58 | 0.00 | 5.00 | 2.00 |
| 23 | 5.00 | 0.00 | 0.00 | 0.00 | 0.00 | 0.00 | 0.00 | 44.83 | 32.17 | 15.00 | 5.00 | 3.00 |
| 24 | 6.11 | 1.67 | 6.11 | 2.86 | 2.86 | 2.86 | 2.86 | 44.00 | 36.36 | 2.86 | 2.86 | 2.50 |
| 25 | 0.00 | 5.00 | 0.00 | 0.00 | 0.00 | 5.00 | 0.00 | 45.42 | 32.58 | 15.00 | 0.00 | 2.00 |

*Abbreviations: EGMP: ethylene glycol bis(3-mercaptopropionate), EHTG: 2-ethylhexyl thioglycolate, TMPMP: trimethylolpropane tris(3-mercaptopropionate), TriMA: trimethylolpropane-trimethacrylate, TMPTA: trimethylolpropane triacrylate, EGDMA: ethylene glycol dimethacrylate, nBA: n-butyl acrylate, MMA: methyl methacrylate, BDA2: 1,4-butandiol diacrylate, AA: acrylic acid.

TABLE 3a
Properties of the prepared polymer latexes of Examples 16 to 25

| | | | | | | | particle |
|---|---|---|---|---|---|---|---|
| | CFG | | Tg | coagulum | solid | | size |
| Polymer | [mol/ | MFFT | (DSC) | [g | content | | (DLS) |
| Latex | kg] | [° C.] | [° C.] | kg⁻¹] | [%] | pH | [nm] |
| 16 | 2.87 | n.d. | −7 | 7.5 | 39.2 | 5.4 | 159 |
| 17 | 1.68 | ≤0 | −24 | 1.0 | 38.8 | 5.6 | 158 |
| 18 | 2.15 | 29 | 24 | 13.3 | 39.2 | 6.4 | 136 |
| 19 | 2.55 | ≤0 | −15 | 12.4 | 39.9 | 5.6 | 156 |
| 20 | 2.40 | n.d. | −15 | 37.5 | 38.8 | 6.2 | 160 |
| 21 | 1.72 | 6 | 13 | 2.0 | 39.5 | 6.6 | 132 |
| 22 | 2.63 | ≤0 | −19 | 56.0 | 38.0 | 6.6 | 154 |
| 23 | 1.73 | ≤0 | +4. | 6.5 | 39.5 | 6.2 | 151 |
| 24 | 2.07 | ≤0 | −13 | 14.5 | 39.3 | 5.9 | 161 |
| 25 | 1.00 | ≤0 | −3 | 1.5 | 39.5 | 7.0 | 135 |

TABLE 3b
Application properties of the polymer latexes of Examples 23 to 38

| | film formed on glass plate |
|---|---|
| Example | tack rating ¹⁾ |
| 16 | 0 |
| 17 | 1 |
| 18 | 0 |
| 19 | 0 |
| 20 | 0 |
| 21 | 0 |
| 22 | 0 |
| 23 | 1 |
| 24 | 0 |
| 25 | 2 |

¹⁾ Rating on a scale from 0 (no tack) to 3 (very tacky)

TABLE 3c

| | Solubility of latexes in an aqueous potassium hydroxide | | |
|---|---|---|---|
| | solution (10% by weight) | | |
| Example | after 6 h RT | after 24 h RT | after 8 d RT |
| 16 | 2 | 0 | 0 |
| 17 | 3 | 3 | 1 |
| 18 | 4 | 4 | 3 |
| 19 | 3 | 0 | 0 |
| 20 | 5 | 2 | 0 |
| 21 | 4 | 4 | 2 |
| 22 | 2 | 0 | 0 |
| 23 | 5 | 3 | 2 |
| 24 | 5 | 0 | 0 |
| 25 | 5 | 5 | 5 |

### Comparative Example 1, Examples 1, 26 to 50 (EDA050004 Series)

The preparations of the Polymers 26 to 50 were carried out in analogy to the preparation of Comparative Example 1, with the exception that the Seed latex 2, the Emulsifier 1, the ethylenically unsaturated monomers and sodium hydroxide are used in amounts listed in table 4. In addition, further components of Feed 1 used for preparing the latexes of Examples 26 to 50, such as crosslinking monomers and chain transfer compounds, are specified and their amounts are listed in table 4. The properties of the obtained latexes as well as their application properties are summarized in tables 5a and 5b.

TABLE 4
Components used for preparing the latexes of Comparative Example 1 and of Examples 39 to 67

| | Seed | | | | | | | | | | |
|---|---|---|---|---|---|---|---|---|---|---|---|
| | latex 1 | Emulsifier 1 | AA* | nBA* | MMA* | BDA2* | AMA* | EHTG* | EGMP* | TMPMP* | NaOH |
| Ex. | [pphm] | [pphm] | [pphm] | [pphm] | [pphm] | [pphm] | [pphm] | [pphm] | [pphm] | [pphm] | [pphm] |
| Comp. | 1.03 | 1.00 | 3.00 | 56.50 | 40.50 | — | — | — | — | — | 0.25 |
| Ex. 1 | | | | | | | | | | | |
| 26 | 1.03 | 1.00 | 3.00 | 52.07 | 38.53 | — | 6.40 | 7.00 | — | — | 0.40 |
| 27 | 1.03 | 1.00 | 3.00 | 48.10 | 42.50 | — | 6.40 | 7.00 | — | — | 0.40 |
| 28 | 1.03 | 1.00 | 3.00 | 44.10 | 46.50 | — | 6.40 | 7.00 | — | — | 0.40 |
| 29 | 1.03 | 1.00 | 3.00 | 40.10 | 50.50 | — | 6.40 | 7.00 | — | — | 0.40 |
| 30 | 1.03 | 1.00 | 3.00 | 50.00 | 37.00 | 10.00 | — | 5.00 | — | — | 0.40 |
| 31 | 1.03 | 1.00 | 3.00 | 50.00 | 37.00 | 10.00 | — | 6.00 | — | — | 0.40 |
| 32 | 1.03 | 1.00 | 3.00 | 50.00 | 37.00 | 10.00 | — | 7.00 | — | — | 0.40 |
| 33 | 1.03 | 1.00 | 3.00 | 50.00 | 37.00 | 10.00 | — | 8.00 | — | — | 0.40 |
| 34 | 1.03 | 1.00 | 3.00 | 50.00 | 37.00 | 10.00 | — | 8.57 | — | — | 0.40 |
| 35 | 1.03 | 1.00 | 3.00 | 52.07 | 38.53 | — | 6.40 | 8.00 | — | — | 0.40 |
| 36 | 1.03 | 1.00 | 3.00 | 52.07 | 38.53 | — | 6.40 | 9.00 | — | — | 0.40 |
| 37 | 1.03 | 1.00 | 3.00 | 52.07 | 38.53 | — | 6.40 | 10.00 | — | — | 0.40 |
| 38 | 1.03 | 1.00 | 3.00 | 50.30 | 36.70 | — | 10.00 | 12.00 | — | — | 0.40 |
| 39 | 1.03 | 1.00 | 3.00 | 49.14 | 35.86 | — | 12.00 | 14.00 | — | — | 0.40 |
| 1 | 1.03 | 1.00 | 3.00 | 50.00 | 37.00 | 10.00 | — | — | 5.00 | — | 0.40 |
| 40 | 1.03 | 1.00 | 3.00 | 50.00 | 37.00 | 10.00 | — | — | 6.00 | — | 0.40 |
| 41 | 1.03 | 1.00 | 3.00 | 50.00 | 37.00 | 10.00 | — | — | 7.00 | — | 0.40 |
| 42 | 1.03 | 1.00 | 3.00 | 50.00 | 37.00 | 10.00 | — | — | 8.00 | — | 0.40 |
| 43 | 1.03 | 1.00 | 3.00 | 50.00 | 37.00 | 10.00 | — | — | 9.00 | — | 0.40 |
| 44 | 1.03 | 1.00 | 3.00 | 50.00 | 37.00 | 10.00 | — | — | 10.00 | — | 0.40 |
| 45 | 1.03 | 1.00 | 3.00 | 50.00 | 37.00 | 10.00 | — | — | — | 4.00 | 0.40 |
| 46 | 1.03 | 1.00 | 3.00 | 50.00 | 37.00 | 10.00 | — | — | — | 5.00 | 0.40 |
| 47 | 1.03 | 1.00 | 3.00 | 50.00 | 37.00 | 10.00 | — | — | — | 6.00 | 0.40 |
| 38 | 1.03 | 1.00 | 3.00 | 50.00 | 37.00 | 10.00 | — | — | — | 7.00 | 0.40 |
| 49 | 1.03 | 1.00 | 3.00 | 50.00 | 37.00 | 10.00 | — | — | — | 8.00 | 0.40 |
| 50 | 1.03 | 1.00 | 3.00 | 50.00 | 37.00 | 10.00 | — | — | — | 9.00 | 0.40 |

*Abbreviations: AA: acrylic acid, nBA: n-butyl acrylate, MMA: methyl methacrylate, BDA2: 1,4-butandiol diacrylate, AMA: allyl methacrylate, EHTG: 2-ethylhexyl thioglycolate, EGMP: ethylene glycol bis(3-mercaptopropionate), TMPMP: trimethylolpropane tris(3-mercaptopropionate).

TABLE 5a
Properties of the prepared polymer latexes

| | | | particle | | | | |
|---|---|---|---|---|---|---|---|
| | solid | | size | | Tg | | |
| | content | | (DLS) | CFG | (DSC) | MFFT | tack |
| Example | [%] | pH | [nm] | [mol/kg] | [° C.] | [° C.] | rating |
| 26 | 38.8 | 4.9 | 142 | 0.47 | −11.7 | n.d. | n.d. |
| 27 | 39.2 | 5.3 | 138 | 0.47 | −6.9 | <0 | n.d. |
| 28 | 39.9 | 6.0 | 138 | 0.47 | 2.6 | 1.0 | n.d. |
| 29 | 39.8 | 6.6 | 137 | 0.47 | 10.9 | 2.0 | n.d. |
| 30 | 39.7 | 6.0 | 139 | 0.96 | −1.2 | ≤0 | 0 |
| 31 | 39.9 | 5.2 | 136 | 0.95 | −5.9 | −3 | 1 |
| 32 | 39.9 | 5.2 | 140 | 0.94 | −10.4 | −4 | 1 |
| 33 | 39.2 | 5.0 | 138 | 0.94 | −14.5 | n.d. | 1 |
| 34 | 39.0 | 5.0 | 143 | 0.93 | −16.3 | n.d. | 1 |
| 35 | 39.2 | 4.6 | 136 | 0.47 | −17.5 | n.d. | 1 |
| 36 | 38.9 | 4.5 | 141 | 0.47 | −19.8 | n.d. | 4 |
| 37 | 39.0 | 4.3 | 138 | 0.46 | −25.2 | n.d. | 5 |
| 38 | 38.6 | 5.9 | 140 | 0.71 | −21.3 | n.d. | 4 |
| 39 | 39.5 | 5.6 | 142 | 0.84 | −25.2 | n.d. | 4 |
| 1 | 39.4 | 6.3 | 154 | 1.36 | −0.2 | ≤0 | n.d. |
| 40 | 39.5 | 6.1 | 156 | 1.43 | −3.3 | ≤0 | n.d. |
| 41 | 39.6 | 5.6 | 156 | 1.49 | −6.0 | ≤0 | n.d. |
| 42 | 39.6 | 5.6 | 159 | 1.56 | −8.7 | ≤0 | n.d. |
| 43 | 39.3 | 5.4 | 166 | 1.62 | −14.1 | n.d. | n.d. |
| 44 | 39.4 | 5.1 | 166 | 1.68 | −14.2 | n.d. | n.d. |
| 45 | 39.8 | 6.7 | 136 | 1.26 | 7.3 | ≤0 | n.d. |
| 46 | 39.5 | 6.6 | 139 | 1.32 | 4.6 | ≤0 | n.d. |
| 47 | 39.8 | 6.5 | 139 | 1.38 | 2.0 | n.d. | n.d. |
| 48 | 39.5 | 6.5 | 141 | 1.44 | 0.1 | n.d. | n.d. |
| 49 | 39.1 | 6.4 | 143 | 1.49 | −2.2 | n.d. | n.d. |
| 50 | 39.1 | 6.3 | 141 | 1.55 | −4.9≤ | n.d. | n.d. |

TABLE 5b

| | Solubility of latexes in an aqueous potassium hydroxide solution (10% by weight) | | |
|---|---|---|---|
| | latex kept | latex kept in | assessment |
| | overnight in KOH | KOH solution for | after ≥14 days in |
| Example | solution | 6 days | KOH solution¹⁾ |
| Comparative Ex. 1 | 5 | 5 | 5 |
| 26 | 3 | 2 | 1 |
| 27 | 5 | 3 | n.d. |
| 28 | 5 | 3 | n.d. |
| 29 | 5 | 4 | n.d. |
| 30 | 4 | 2 | 1 |
| 31 | 4 | 2 | 1 |
| 32 | 4 | 2 | 1 |
| 33 | 4 | 1 | 0 |
| 34 | 2 | 1 | 0 |
| 35 | 3 | 2 | 1 |
| 36 | 3 | 2 | 1 |
| 37 | 3 | 2 | 1 |
| 38 | 5 | 1 | 1 |
| 39 | 5 | 1 | 1 |
| 1 | 2 | 1 | 1 |
| 40 | 2 | 1 | 0 |
| 41 | 2 | 1 | 0 |
| 42 | 2 | 1 | 0 |
| 43 | 1 | 1 | n.d. |
| 44 | 1 | 1 | n.d. |
| 45 | 4 | 2 | 1 |
| 46 | 4 | 2 | 1 |
| 47 | 4 | 2 | 1 |
| 48 | 4 | 1 | 0 |
| 49 | 3 | 1 | 0 |
| 50 | 3 | 1 | 0 |

¹⁾After the latex had been kept in the KOH solution for ≥14 days, the assessment was performed following brief shaking the sample under illumination with a laser pointer.

### Measuring of the Wet Scrub Resistance of Waterborne Coating Compositions

For testing the application properties of waterborne coating compositions containing the latexes of Examples 26 to 29 and of Comparative Example 1, paint formulations were formulated using the following recipe:

| | parts by weight |
|---|---|
| water | 272 |
| Thickener | 4 |
| Sodium hydroxide (10% by weight in water) | 2 |
| Polyphosphate (10% by weight in water) | 5 |
| Dispersant | 3.5 |
| TiO₂ Pigment | 80 |
| Filler 1 | 35 |
| Filler 2 | 235 |
| Filler 3 | 205 |

The above mixture was dispersed for approx. 20 min. Then the following ingredients were added:

| | parts by weight |
|---|---|
| Defoamer | 2 |
| aqueous polymer latex (50% by weight) | 132.5 |
| water | 24 |
| total | 1000 |

### Measurement of Wet Scrub Resistance

The wet scrub resistance (WSR) of the latex paints prepared was tested by means of the nonwoven pad method in accordance to ISO 11998. WSR was assessed on the basis of the weight loss per unit area by abrasion caused by 40 strokes with a sandpaper (Scotch Brite No. 7448 CP ultra-fine, grey) and calculated back to an average thickness loss given in μm. In addition, the grades according to DIN EN 13300 are given, where:
Grade 1 means wet scrub abrasion <5 μm at 200 strokes
Grade 2 means wet scrub abrasion >5 to <20 μm at 200 strokes
Grade 3 means wet scrub abrasion >20 to <70 μm at 200 strokes
Grade 4 means wet scrub abrasion <70 μm at 40 strokes
Grade 5 means wet scrub abrasion >70 μm at 40 strokes

The results are summarized in the following Table 6. The waterborne coating compositions or latex paints P26 to P29 and CP1 were prepared with the aqueous polymer latexes of Examples 26 to 29 and Comparative Example 1, respectively, as binders.

TABLE 6

| | | Wet scrub | Grade as per evaluation |
|---|---|---|---|
| | Binder | abrasion | according to |
| Paint | (Ex. No.) | [μm] | DIN EN 13300 |
| CP1 | Comp. | 25 | 4 |
| | Ex. 1 | | |
| P26 | 26 | 58 | 4 |
| P27 | 27 | 37 | 4 |
| P28 | 28 | 24 | 4 |
| P29 | 29 | 19 | 4 |

From the results summarized in Table 6, it can be seen that the use of polymer latexes according to the invention as binders in latex paints leads to coatings with satisfactory wet abrasion resistance. In particular, the paints prepared from the latexes of Examples 26-29 with relatively high glass transition temperatures exhibit wet scrub resistances of the same order of magnitude as the paint prepared from the latex of Comparative Example 1.

1.-20. (canceled)

21. An aqueous polymer dispersion of a polymer P obtained by emulsion polymerization of ethylenically unsaturated monomers M and at least one chain transfer compound C, where the monomers M comprise at least one monoethylenically unsaturated monomer M1 and at least one multiethylenically unsaturated monomer M2, where the polymer P comprises a multitude of hydrolytically cleavable functional groups CFG within its carbon chain formed by the polymerization of the ethylenically unsaturated double bonds of the monomers M such that the functional groups CFG interrupt the carbon chain of the polymer P, where the relative amount of the functional groups CFG is in the range of 0.1 to 20 mol*kg⁻¹ of the polymer P.

22. The aqueous polymer dispersion of claim 21, wherein the cleavable functional groups CFG are selected from the group consisting of —C(O)O—, —C(O)NH—, —C(O)S—, —C(O)NHC(O)—, —NHC(O)NH—, —S(O)₂O—, —OC(O)NH—, —SC(O)NH— and combinations thereof.

23. The aqueous polymer dispersion of claim 22, wherein cleavable functional groups CFG in the polymer P comprise —C(O)O— groups.

24. The aqueous polymer dispersion of claim 21, wherein the chain transfer compound C has at least 2 functional groups CTG which are capable of providing a chain transfer during polymerization of the monomers M.

25. The aqueous polymer dispersion of claim 24, wherein the functional groups CTG are mercapto groups (SH).

26. The aqueous polymer dispersion of claim 24, wherein the at least 2 functional groups CTG are connected by a spacer group which comprises at least one functional group CFG.

27. The aqueous polymer dispersion of claim 26, wherein the chain transfer compound C is selected from compounds of the formulae (C-1) or (C-2): 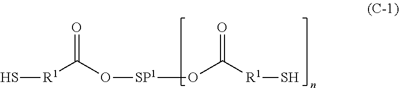
where
n is an integer from 1 to 5,
R¹ is C₁-C₆ alkandiyl and
SP¹ is a n+1 valent organic radical having 2 to 40 carbon atoms and 0 to 12 heteroatoms, where the heteroatoms are selected from the group consisting of O, N and S; 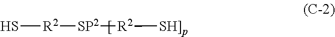
where
p is an integer from 1 to 5,
R² is C₁-C₆ alkandiyl and
SP² is a single bond or a p+1 valent organic radical having 1 to 40 carbon atoms and 0 to 12 heteroatoms, where the heteroatoms are selected from the group consisting of O, N and S.

28. The aqueous polymer dispersion of claim 21,
wherein the chain transfer compound C is selected from the group consisting of ethylene glycol bis(3-mercaptopropionate), pentaerythritol tetrakis(3-mercaptopropionate), trimethylolpropane tris(3-mercaptopropionate), pentaerythritol tetrakis(3-mercaptobutyrate), bis(2-mercaptoethyl) sulfone, 4-(mercaptomethyl)-3,6-dithia-1,8-octanedithiol, pentaerythritol tetrakis(mercaptoethyl-polyoxyethylene), poly(ethyleneglycol) dithiol, reaction products of 3-isocyanatomethyl-3,5,5-trimethylcyclohexyl isocyanate and trimethylolpropane tris(3-mercaptopropionate), pentaerythritol tetrakis(3-mercaptobutyrate-polyoxyethylene), tris[2-(3-mercaptopropionyloxy)ethyl]isocyanurate, 1,6-hexanediol bis(3-mercaptopropionate), 1,4-cyclohexanediol bis(3-mercaptopropionate) and 2,2-bis(4-hydroxycyclohexyl)-propane bis(3-mercaptopropionate), n-dodecyl mercaptan, tert-dodecyl mercaptan, 2-ethylhexyl 3-mercaptopropionate, isooctyl 3-mercaptopropionate, 2-mercapto acetic acid, 3-mercapto propionic acid, butyl 2-mercaptoacetate, butyl 3-mercaptopropionate 2-ethylhexyl 2-mercaptoacetate, isooctyl 2-mercaptoacetate, and combinations thereof.

29. The aqueous polymer dispersion of claim 21, wherein the monomer M2 has at least one cleavable functional group CFG, and wherein the ethylenically unsaturated double bonds and the functional groups CFG in the monomers M2 are combined to form an acrylate or methacrylate group.

30. The aqueous polymer dispersion of claim 21, wherein the ethylenically unsaturated double bonds of the monomer M2 are connected by a spacer group which comprises at least one functional group CFG or where the chain transfer compound C has at least 2 functional groups CTG which are capable of providing a chain transfer during polymerization of the monomers M wherein the at least 2 functional groups CTG are connected by a spacer group which comprises at least one functional group CFG.

31. The aqueous polymer dispersion of claim 21, wherein the monomer M2 is selected from compounds of the formula M2-1 and M2-2 and combinations thereof, 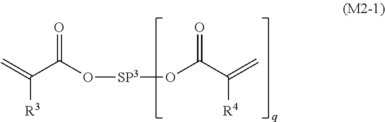
where in formula M2-1
q is an integer from 1 to 5,
R³ is H or methyl,
R⁴ is H or methyl and
SP³ is a q+1 valent organic radical having 2 to 40 carbon atoms and 0 to 12 heteroatoms, where the heteroatoms are selected from the group consisting of O, N and S; 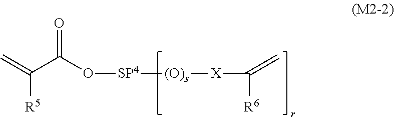
r is an integer from 1 to 5,
s is 0 or 1,
X is a single bond or CH₂,
R⁵ is H or methyl,
R⁶ is H or methyl and
SP⁴ is a r+1 valent organic radical having 2 to 40 carbon atoms and 0 to 12 heteroatoms, where the heteroatoms are selected from the group consisting of O, N and S or, if q is 1, SP⁴ may also be a single bond, provided that s is 1, if SP⁴ is a single bond.

32. The aqueous polymer dispersion of claim 21, wherein the monomer M2 is selected from the group consisting of ethylene glycol diacrylate, ethylene glycol dimethacrylate, trimethylolpropane triacrylate, trimethylolpropane trimethacrylate, trimethylolpropane ethoxylate triacrylate, trimethylolpropane ethoxylate trimethacrylate, pentaerythritol triacrylate, pentaerythritol trimethacrylate, pentaerythritol tetraacrylate, pentaerythritol tetramethacrylate, tetra(ethylene glycol) diacrylate, tetra(ethylene glycol) dimethacrylate, di(ethylene glycol) diacrylate, di(ethylene glycol) dimethacrylate, 1,3-butandiol diacrylate, 1,3-butandiol dimethacrylate, 1,4-butandiol diacrylate, 1,4-butandiol dimethacrylate, 1,6-hexandiol diacrylate, 1,6-hexandiol dimethacrylate, poly(ethylene glycol) diacrylate, poly(ethylene glycol) dimethacrylate, 1,1-bis(2-acryloyloxy ethoxy)-[4-methoxy-phenyl]methane, 1,1-bis(2-methacryloyloxy ethoxy)-[4-methoxy-phenyl]methane, bis(2-acryloyloxy ethyl) disulfide, bis(2-methacryloyloxy ethyl) disulfide, allyl acrylate, 2-methylallyl acrylate, vinyl acrylate, 2-(vinyloxy)ethyl acrylate, allyl methacrylate, 2-methylallyl methacrylate, vinyl methacrylate, 2-(vinyloxy)ethyl methacrylate, and combinations thereof.

33. The aqueous polymer dispersion of claim 21, wherein the polymer P is formed from polymerized units of a mixture of the monomers M and the chain transfer agent C, where the mixture comprises
a) 60 to 97% by weight by weight of at least one monoethylenically unsaturated monomer M1;
b) 2 to 25% by weight by weight of at least one multiethylenically unsaturated monomer M2;
c) 1 to 25% by weight by weight of at least one chain transfer compound C;
where the percentages given here amount to 100% by weight and are based on the total weight of monomers M+chain transfer compound C in the mixture and where the ethylenically unsaturated double bonds of the monomer M2 are connected by a spacer group which comprises at least one functional group CFG, which is not a chain transfer group or where the chain transfer compound C has at least 2 functional groups CTG which are capable of providing a chain transfer during polymerization of the monomers M wherein the at least 2 functional groups CTG are connected by a spacer group which comprises at least one functional group CFG.

34. The aqueous polymer dispersion of claim 21, wherein the total amount of chain transfer agent C and monomer M2, i. e. the total amount of M2+C, is in the range of 3 to 40% by weight, based on the total weight of monomers M+chain transfer compound C.

35. The aqueous polymer dispersion of claim 21, wherein the molar ratio of the total amount of functional groups CTG of the chain transfer agent C and the total amount of ethylenically unsaturated double bonds of the monomer M2 is in the range of 10:1 to 1:6.

36. The aqueous polymer dispersion of claim 21, wherein the ethylenically unsaturated monomers M1 comprise at least one monomer M1.1 which is selected from alkyl acrylates, alkyl methacrylates, cycloalkyl acrylates, cycloalkyl methacrylates, vinylesters of saturated aliphatic acids, monovinyl aromatic compounds and mono-olefins.

37. The aqueous polymer dispersion of claim 36, wherein the monoethylenically unsaturated monomers M1 additionally comprise a monoethylenically unsaturated monomer M1.2 bearing an acid group selected from SO₃H, OSO₃H, PO₃H₂, OPO₃H₂ and CO₂H, where the acid group may be present in its protonated form or in its salt form.

38. The aqueous polymer dispersion of claim 37, wherein the relative amount of the monoethylenically unsaturated monomers M1.2 is in the range of 0.1 to 10% by weight, based on the total weight of the monomers M1.

39. A method for producing an aqueous polymer dispersion of claim 21, the method comprising polymerizing, via aqueous emulsion polymerization, the monomers M and the chain transfer compound, wherein the amount of the chain transfer compound C and the type and amount of monomers M2 is chosen such that the resulting polymer contains functional groups CFG which interrupt the carbon chain of the polymer provided, where the relative amount of the functional groups CFG is in the range of 0.1 to 20 mol*kg⁻¹ of the polymer P.

40. A binder comprising the aqueous polymer dispersion of claim 21.
